(19) United States
(12) Patent Application Publication
(10) Pub. No.: US 2026/0295624 A1
(43) Pub. Date: Oct. 1, 2026

(54) MONITOR AND FLOW DEVICE ASSEMBLY INCLUDING THE SAME

(71) Applicant: HEN NOZZLES INC., Hayward, CA (US)

(72) Inventors: Nicholas James McKibben, Oakland, CA (US); Grant Harrison Friesen, Concord, CA (US); John McDonald, Oakland, CA (US); Sagar Bhatia, Fremont, CA (US); Sunny Sethi, Dublin, CA (US)

(21) Appl. No.: 19/633,666

(22) Filed: Mar. 30, 2026

Related U.S. Application Data
(60) Provisional application No. 63/781,574, filed on Apr. 1, 2025.

(51) Int. Cl. B05B 15/652; A62C 31/28; B05B 15/63

(52) U.S. Cl. CPC B05B 15/652; A62C 31/28; B05B 15/63

(57) ABSTRACT

A flow device assembly can include a monitor having an inlet, an outlet, a fluid pathway extending from the inlet through the outlet, and an adjustment component. The outlet can include a rotatable element to connect to one or more components, and the adjustment component can rotate the rotatable element about an axis of rotation about parallel to the fluid pathway at the outlet. The flow device assembly can further include a rotation motor to adjust a rotation of the monitor relative to a first axis parallel to the fluid pathway at the inlet. The flow device assembly can include an elevation motor to adjust an elevation of the monitor.

### CROSS-REFERENCE TO RELATED APPLICATIONS

This application claims priority to U.S. Provisional Application No. 63/781,574, filed Apr. 1, 2025, titled “MONITOR AND FLOW DEVICE ASSEMBLY INCLUDING THE SAME,” the disclosure of which is incorporated herein by reference in its entirety for all purposes.

### BACKGROUND

### Field

The field relates to flow device assemblies, including monitors.

### Description of the Related Art

Monitors for delivering high fluid flows, such as for firefighting or deicing applications, can facilitate the discharge of a large amount of fluid in a short period of time. Consequently, monitors can be very heavy and bulky, and retrofitting them to surfaces (e.g., a truck roof or bumper, or an aerial platform) can be difficult. The requirements for the fluid pathway within a monitor can make it challenging to fabricate a monitor that is more compact. Some monitors may include rotational mechanisms including motors, so that the exiting fluid can be aimed at different locations. The implementation of motors can mean the inclusion of electrical wiring, which is often located outside of a housing of the monitor. Thus, a compact monitor that can be more readily retrofitted to surfaces is desired.

### BRIEF DESCRIPTION OF THE DRAWINGS

FIG. 1 is a front and left perspective view of a flow device assembly for firefighting applications, according to one embodiment.

FIGS. 2A-2C are front, back, and left side elevational views, respectively, of the monitor in the flow device assembly of FIG. 1.

FIGS. 3A-3H illustrate various components of the monitor of FIGS. 2A-2C. FIG. 3A is an exploded view of the monitor. FIG. 3B is a perspective view of a monitor body. FIG. 3C is a cross-sectional top view of the monitor body. FIG. 3D is a perspective view of an outlet arm of the monitor. FIG. 3E is a semi-transparent top view of the outlet arm. FIG. 3F is a perspective view of an elevation drive assembly of the monitor. FIG. 3G is a cross-sectional top view of the elevation drive assembly. FIG. 3H is a rear elevational cross-section of the monitor.

FIGS. 4A-4E show schematic flow paths in a monitor, according to one embodiment. FIG. 4A is a perspective view of a monitor with a schematic flow path. FIG. 4B is a front elevation view of the monitor with the schematic flow path. FIG. 4C is a left side elevation view of the monitor with the schematic flow path. FIG. 4D is a cross-sectional front elevation view of the monitor with the schematic flow path. FIG. 4E is a cross-sectional top view of the monitor with the schematic flow path.

FIGS. 5A-5I illustrate a restriction and shut-off element that can be implemented with a monitor, as shown in FIG. 1, according to one embodiment. FIG. 5A is a perspective left and front view of the restriction and shut-off element. FIG. 5B is a side cross-sectional view of the restriction and shut-off element with the motor housing omitted. FIG. 5C illustrates an opening of a ball valve. FIG. 5D illustrates openings of individual restriction components. FIG. 5E is a side elevation view of the restriction and shut-off element with the motor housing omitted. FIG. 5F schematically shows the alignments and axes of rotation for the ball valve and restriction components. FIGS. 5G-5I shows different opening and restriction states of the restriction and shut-off element.

FIGS. 6A-6B illustrate a stream straightener that can be implemented with a monitor, as shown in FIG. 1, according to one embodiment. FIG. 6A is a back and right perspective view of the straightener. FIG. 6B is a semi-transparent back and right perspective view of the straightener, showing the internal sensors and stream straightener elements.

FIGS. 7A-7B are side cross-sectional views of a straightener that can be implemented with a monitor, according to different embodiments.

FIGS. 8A-8F illustrate a nozzle that can be implemented with a monitor, as shown in FIG. 1, according to one embodiment. FIG. 8A is a front and left perspective view of the nozzle. FIG. 8B is a side cross-sectional view of the downstream components within the nozzle. FIG. 8C is a side cross-sectional view of the nozzle and FIG. 8D is a corresponding front elevational view of the nozzle with the nozzle in one operational state. FIG. 8E is a side cross-sectional view of the nozzle and FIG. 8F is a corresponding front elevation view of the nozzle in another operational state.

### DETAILED DESCRIPTION

### Flow Device Assembly

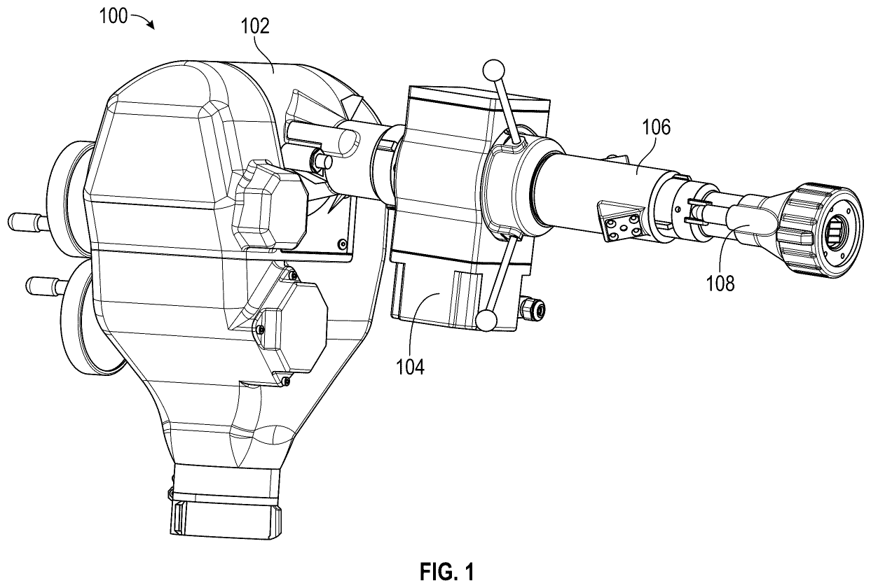

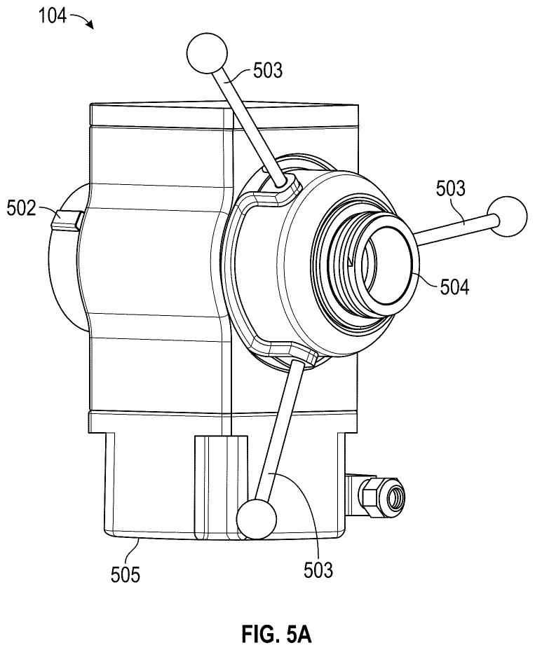

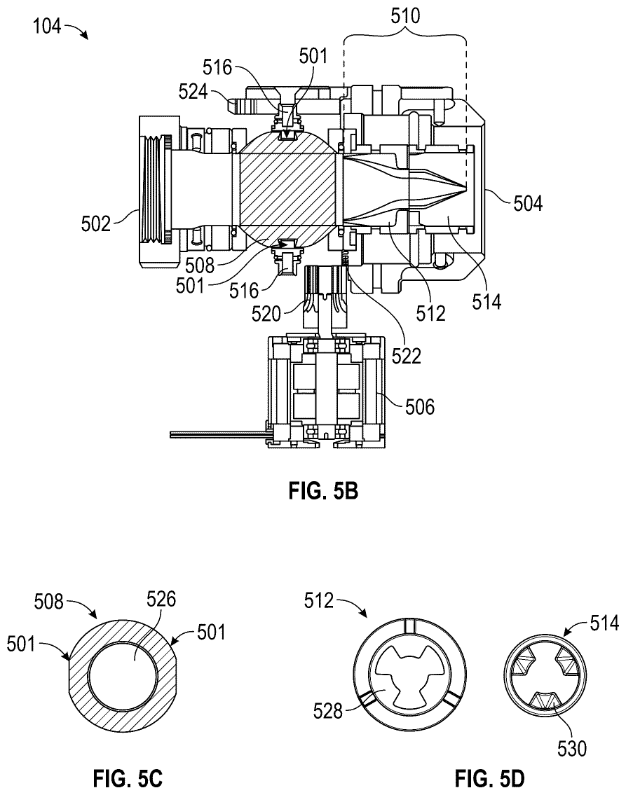

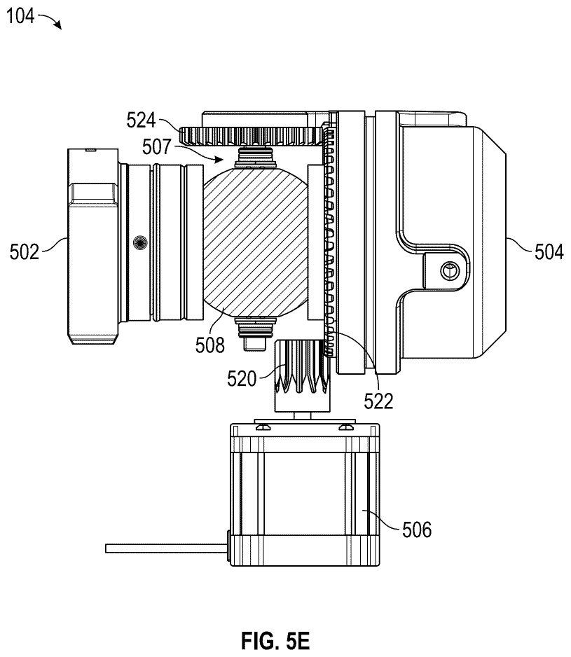

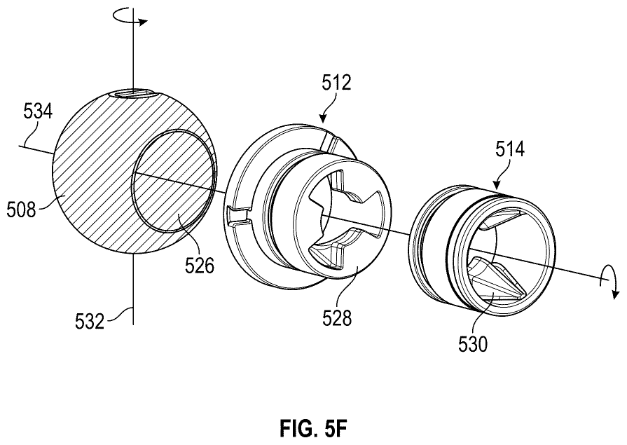

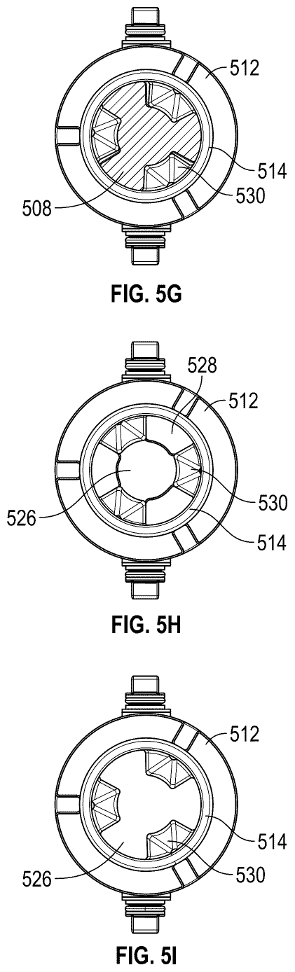

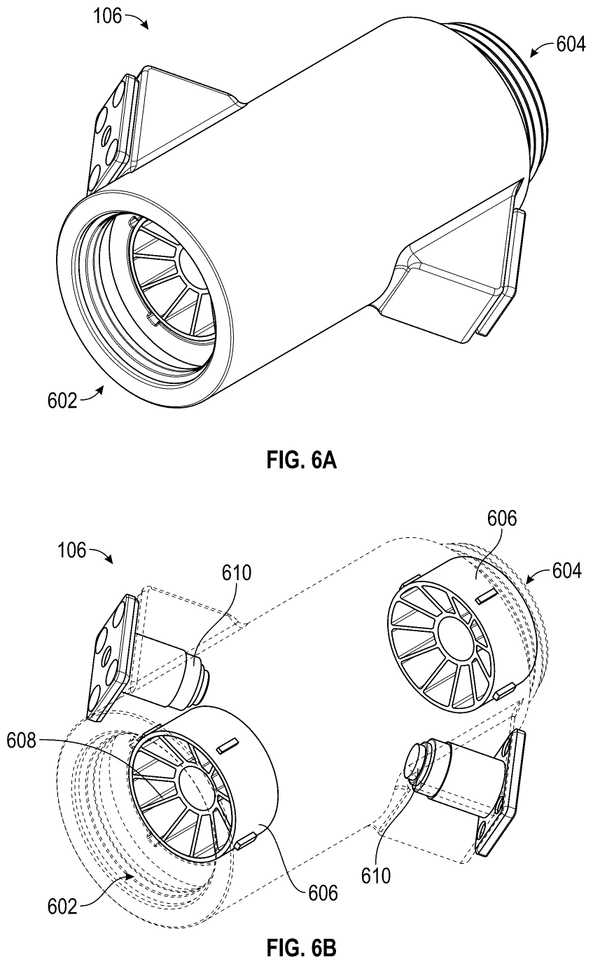

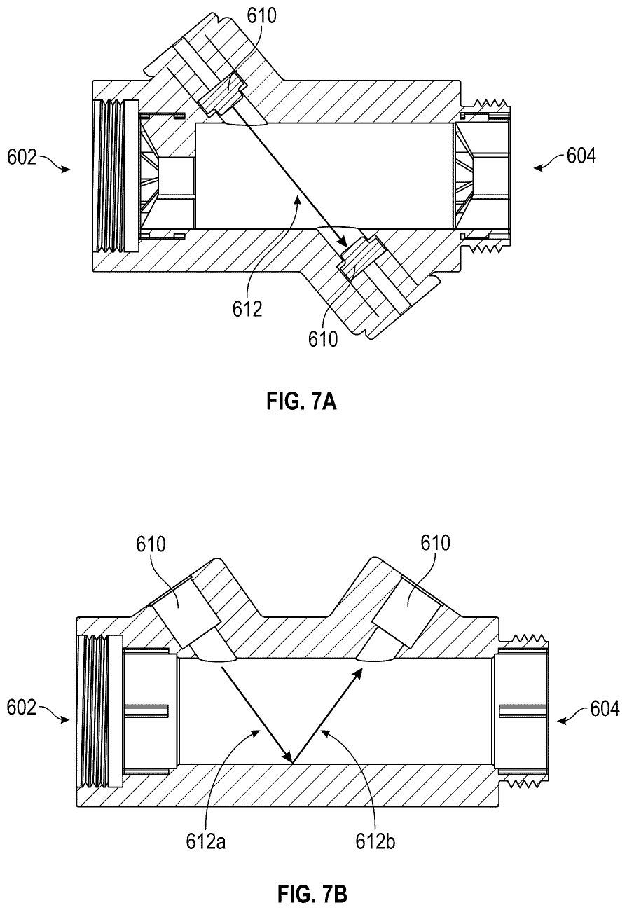

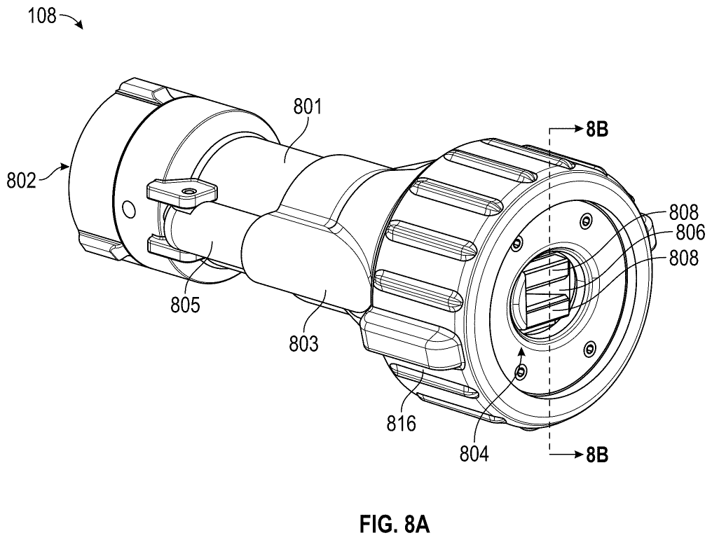

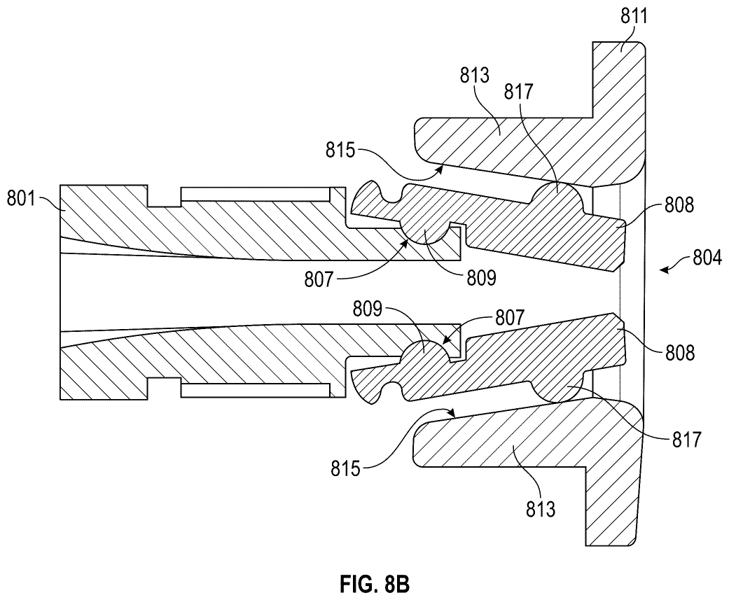

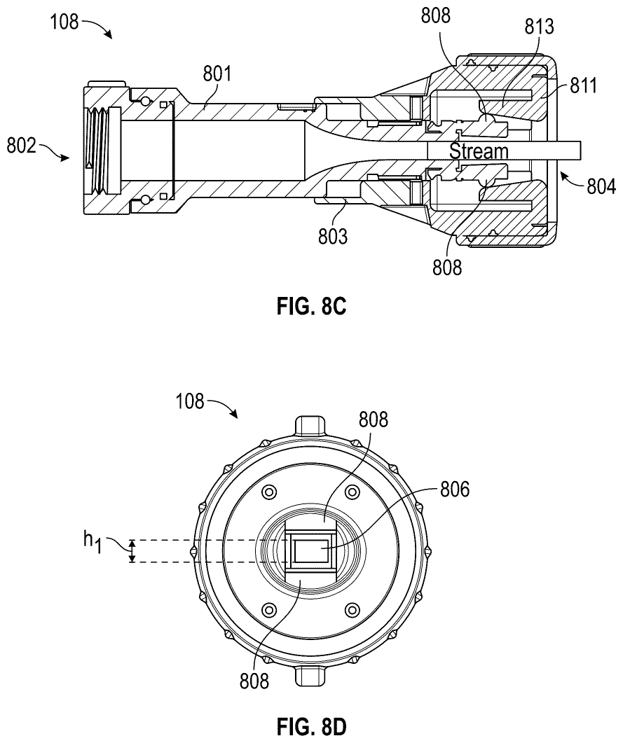

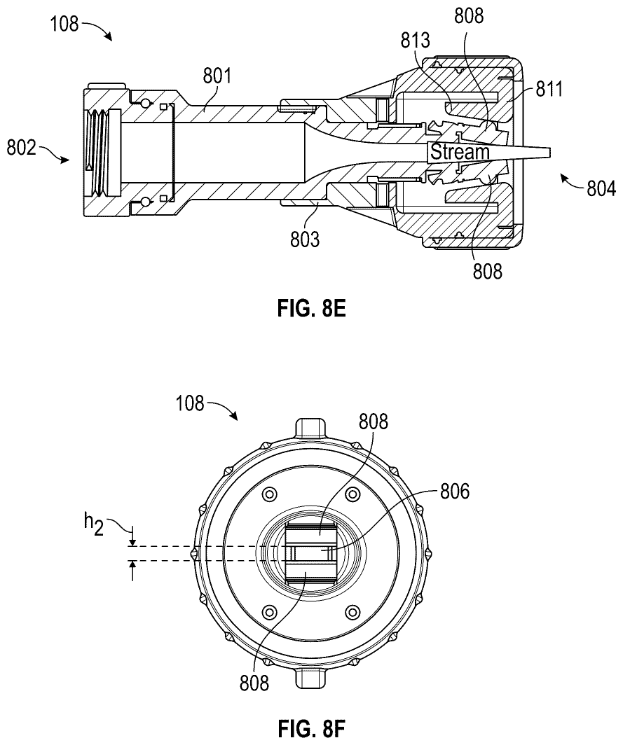

FIG. 1 illustrates a flow device assembly 100. As used herein, the flow device assembly 100 is configured for surface-mounted operation, as opposed to hand-held assemblies used with hoses, and may also be referred to as a turret assembly, a monitor system, a deck gun, a water cannon, a deluge gun, etc. The flow device assembly 100 is configured for relatively high-volume flows, such as for surface-mounted firefighting or plane de-icing applications. The flow device assembly 100 can include a monitor 102 and additional downstream components. In the illustrated embodiment, the flow device assembly 100 also includes a restriction and shut-off element 104 coupled or attached to the monitor 102, a stream straightener component 106 coupled or attached to the restriction and shut-off element 104, and a nozzle 108 coupled or attached to the stream straightener component 106. One or more of these downstream components can be omitted, and other components can be used instead or in addition to the illustrated components. The restriction and shut-off element 104, as described further with respect to FIGS. 5A-5I, can include an integrated shut-off element, and it can allow for adjusting back pressure in the monitor 102 using a twisting mechanism that can also control the integrated slow-close shut-off element. The stream straightener component 106 can include a component for measuring flow rate and one or more integrated stream straighteners, as described further with respect to FIGS. 6A-7B. The nozzle 108 can be adjustable to have multiple stream patterns (e.g., symmetrical in two dimensions perpendicular to the flow or flat and spread out (e.g., fan-shaped, flat and triangular-shaped, v-shaped, having a shape corresponding to the vertical cross-section of a cone, etc.), and it can operate in a range of approximately 20 GPM to 500 GPM, as described further with respect to FIGS. 8A-8E.

In some cases, the flow device assembly 100 is configured to include manual options for operating various components (e.g., at least one of the monitor 102, the restriction and shut-off element 104, and the nozzle 108) within the flow device assembly 100. In some cases, the flow device assembly 100 is configured to include motorized options for operating the various components (e.g., at least one of the monitor 102, the restriction and shut-off element 104, and the nozzle 108) within the flow device assembly 100.

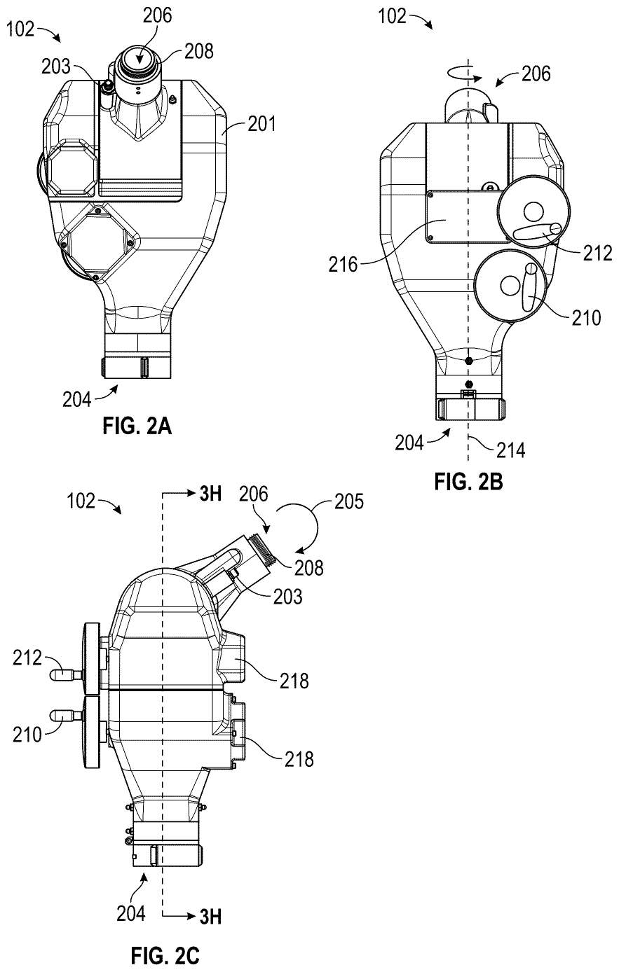

The monitor 102 can have a variety of sizes depending on the application. The monitor 102 includes an inlet (e.g., inlet 204 in monitor 102 of FIGS. 2A-2C) and an outlet (e.g., outlet 206 in monitor 102 of FIGS. 2A-2C). Accordingly, the diameters of the inlet and outlet will also vary in size depending on the application. In some cases, the monitor 102 may be a small monitor designed to be attached to a brush truck, a deicing vehicle, etc. A small monitor may have a maximum flow rate of approximately 200-800 gallons per minute (GPM), such as about 500 GPM. In some cases, the inlet can have a diameter in a range between approximately 1.7″ and 2.8″, such as about 2.0″, or about 2.5″. The outlet can have a diameter in a range between approximately 1.3″ and 1.7″, such as about 1.5″. The inlet and outlet diameters of the small monitor are not limited to the example ranges and may include other values.

In some cases, the monitor 102 may be a medium monitor designed to be attached to a firefighting vehicle or similar (e.g., a deck gun). A medium monitor may have a maximum flow rate of approximately 1000-1500 GPM, such as about 1250 GPM. In some cases, the inlet can have a diameter in a range between approximately 2.7″ and 4.3″, such as about 3.0″, 3.5″, or 4.0″. The outlet can have a diameter in a range between approximately 2.2″ and 2.8″, such as about 2.5″. The inlet and outlet diameters of the medium monitor are not limited to the example ranges and may include other values.

In some cases, the monitor 102 may be considered a large monitor designed to be implemented in aerials or industrial facilities. A large monitor may have a maximum flow rate of approximately 1550-3000 GPM, such as about 2000 GPM. In some cases, the inlet can have a diameter in a range between approximately 4.2″ and 4.8″, such as about 4.5″. The outlet can have a diameter in a range between approximately 3.2″ and 3.8″, such as about 3.5″. The inlet and outlet diameters of the large monitor are not limited to the example ranges and may include other values.

In some cases, the inlet can comprise a standardized diameter allowing the monitor 102 to couple to a variety of readily available flange bases, and the outlet can comprise a customizable diameter. The outlet diameter may depend on the dimensions of the connection or coupling elements of the downstream components. In some cases, the outlet diameter may also comprise a standardized diameter allowing the monitor 102 to couple to a variety of commercially available downstream components (e.g., nozzles).

### Monitor

FIGS. 2A-2C show the monitor 102 of the flow device assembly of FIG. 1, according to one embodiment.

In FIG. 2A, a front elevation view of the outlet side (e.g., front side) of the monitor 102 is illustrated. The monitor 102, having a housing 201 can be attached or fixed to an external surface at the bottom of the monitor 102. In some embodiments, the housing 201 can comprise metal, and can be monolithically formed of metal. For example, the housing 201 can be formed out of aluminum, or steel (e.g., stainless steel, carbon steel, etc.). In some embodiments, the housing 201 can be formed using a 3D printing technique. For example, the housing 201 can be formed using selective laser sintering (SLS) or selective laser melting (SLM). In some cases, a housing 201 made from aluminum can be formed using an SLS process. In some embodiments, the housing 201 or various components of the monitor 102 can be formed using multi jet fusion (MJF) 3D printing, where the material can be a nylon material. In some cases, casting (e.g., aluminum casting or some other metal casting) can be used to produce the housing 201. The casting process may be implemented in high-volume production. In some cases, plastics, like nylon, can be used to form the housing 201, and the plastic may be molded, such as injection molded.

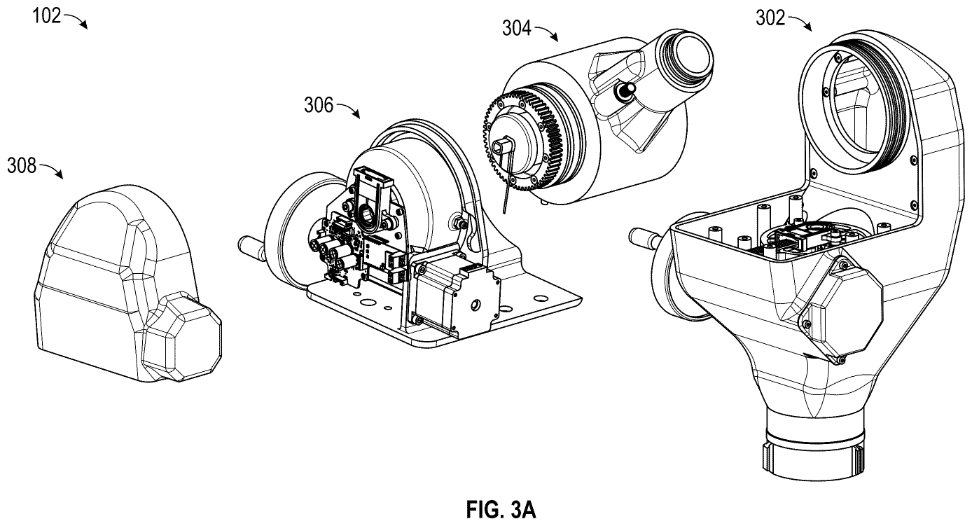

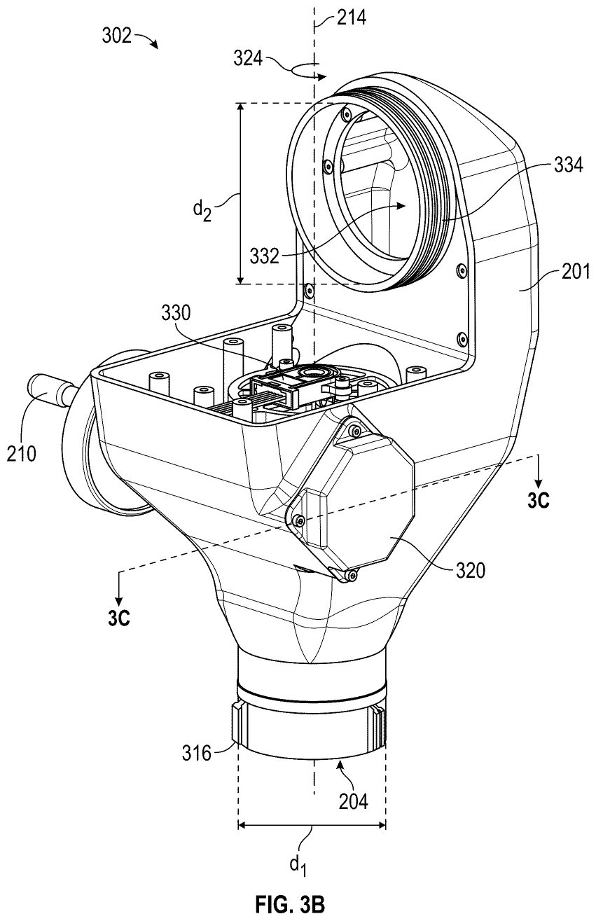

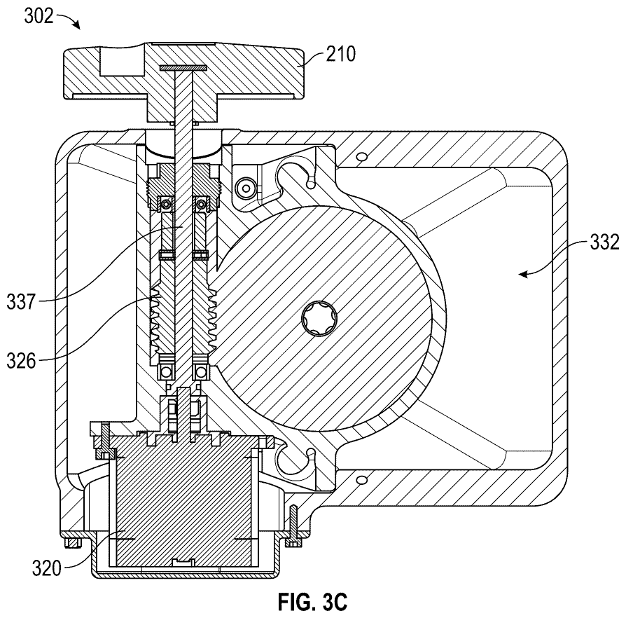

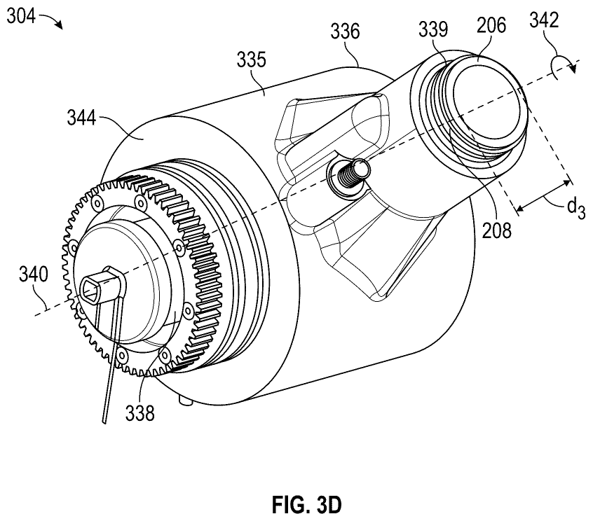

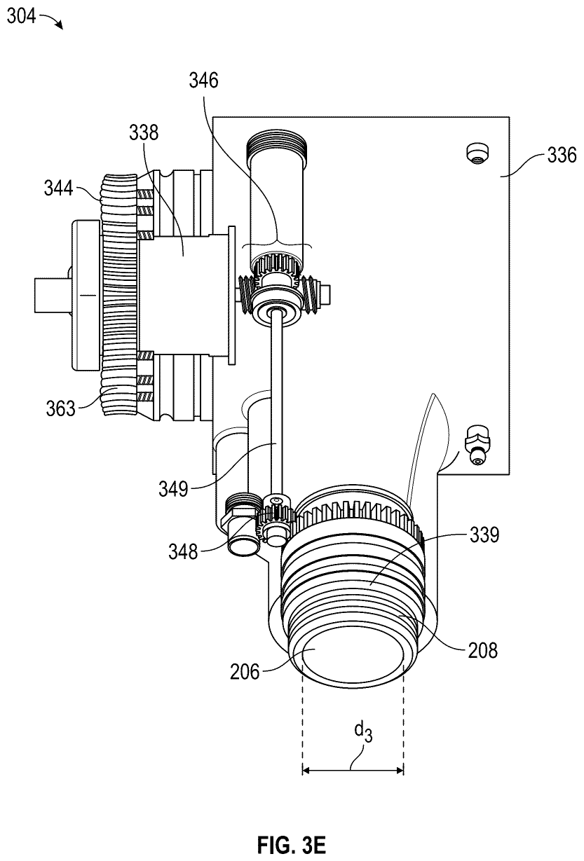

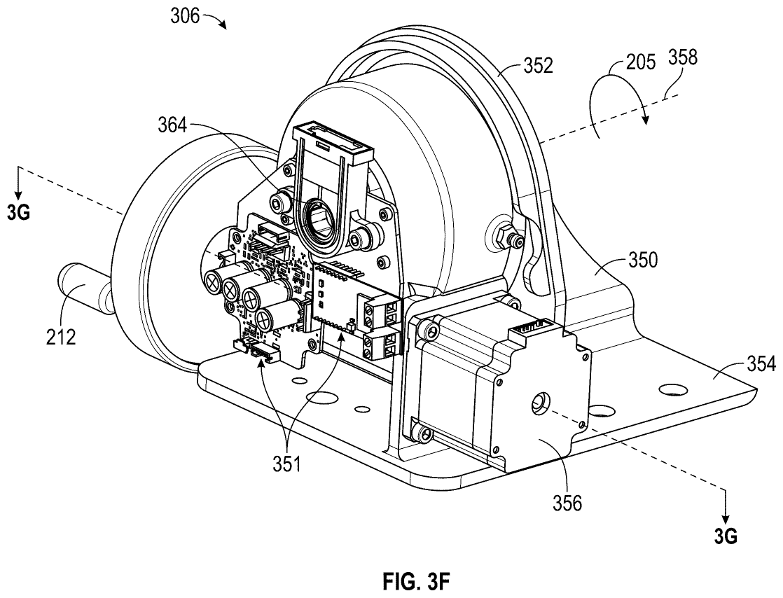

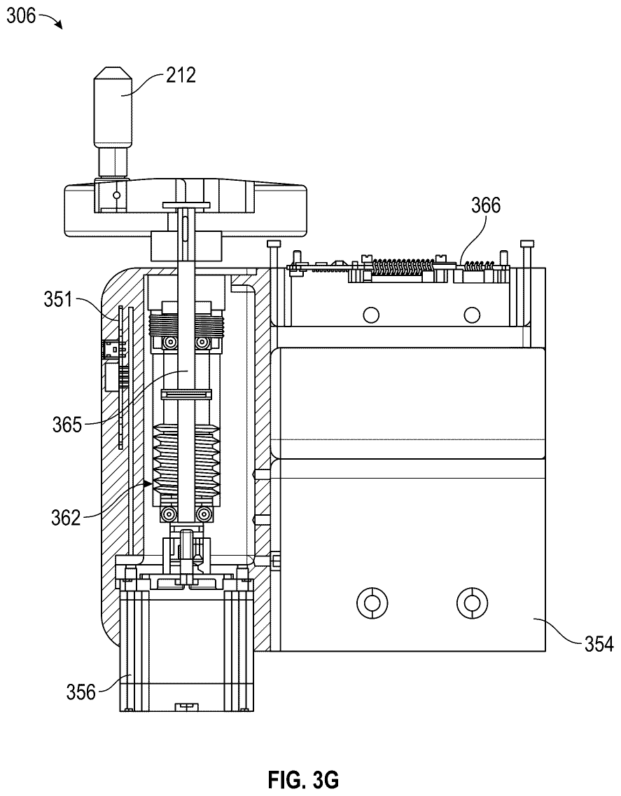

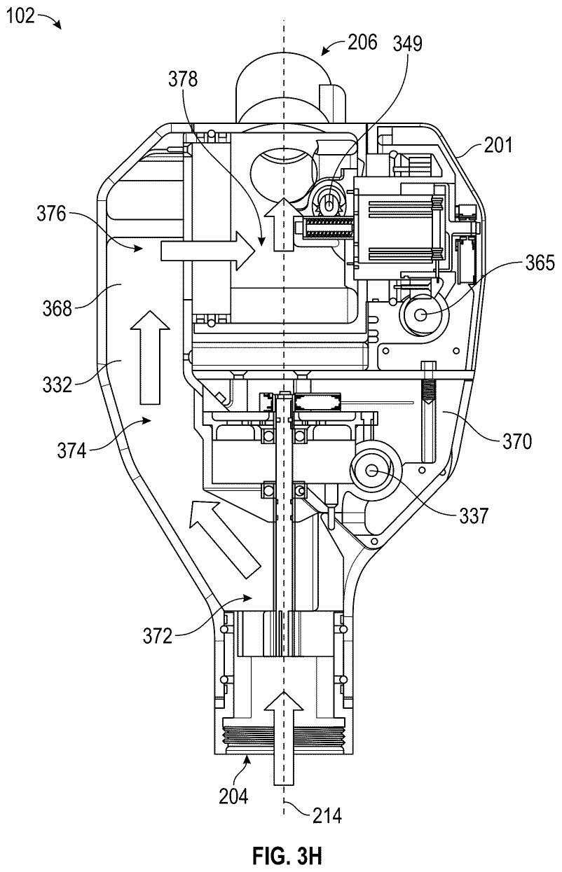

The monitor 102 can include an inlet 204, and an outlet 206, which can be viewed on the outlet side of the monitor 102. The outlet 206 can be internally or externally threaded (e.g., external threaded portion 208) to facilitate attachment of additional downstream components to the monitor 102. In some embodiments, the outlet 206 may be coupled to a motor (e.g., a motor 338 in FIG. 3E) to enable a rotation of the threaded portion 208, as shown in FIG. 3D, about an axis about parallel to the flow direction. Such rotation is also referred to as the “orientation” of the outlet, and it can also affect the orientation of downstream components such as the nozzle 108 (FIG. 1), and consequently affect the orientation of an output of a flow device assembly (e.g., affect the orientation of a nozzle output).

FIG. 2B shows a back elevational view of the crank side (e.g., back side) of the monitor 102. Depicted are two handles that can enable manual adjustments of the monitor 102. For example, a first handle (e.g., rotation handle 210) can manually adjust a rotation (e.g., yaw rotation or azimuth adjustment) of the monitor 102 about an axis 214 (e.g., central vertical axis), and a second handle (e.g., an elevation handle 212) can manually adjust an elevation (e.g., up/down, pitch, or zenith adjustment) of the outlet 206 of the monitor 102. In some cases, one or more of the handles are fold-away handles with grooves to accommodate the folded handles, so that the handles do not protrude in normal operation. The handles 210, 212 can be used in the absence of power or if the motors or control electronics otherwise fail. FIG. 2B further illustrates a circuit board region 216, which can house a circuit board (e.g., circuit board 366 in FIG. 3G) (e.g., a printed circuit board array (PCBA)) within the monitor 102. The circuit board can be electrically connected to one or more motors that can be included within the monitor 102. The circuit board can also communicate with outside control systems (e.g., truck control panel), either wirelessly or by way of plug-in electrical connections. For example, an integrated pin-and-socket electrical connection can be provided at the inlet 204 (not shown) and the mounting surface, or vice versa. The connection may, for example, be a 9-pin connection and be internally wired within the monitor 102 to the various motor controls discussed herein and to the connector 203. Alternatively, an electrical connector, similar to connector 203 described below, may be provided for power supply from the mounting surface to the monitor 102, and control signals for the motors can be provided wirelessly.

In some cases, additional (e.g., peripheral) electrical elements associated with downstream components that may be attached to the monitor 102 may be electrically connected to the monitor 102 through the connector 203 shown in FIGS. 2A and 2C. In some cases, a downstream component to be attached to the monitor 102 may include at least one electrical connector. For example, if the downstream component is the stream straightener component 106, it may include two electrical connectors. The first electrical connector can facilitate electrical connection of the stream straightener 106 to the monitor 102 and/or the restriction and shut-off element 104, and the second electrical connector can facilitate electrical connection between the stream straightener component 106 and any further downstream components (e.g., nozzle 108). In another example, the nozzle 108 may include one electrical connector if it is the last downstream component to be attached to the flow device assembly 100. In some cases, the wiring strategy implemented to electrically connect the monitor 102 and any additional downstream components (e.g., restriction and shut-off element 104, stream straightener component 106, nozzle 108) can be a daisy chain wiring scheme. The electrical connector 203 can supply power from the monitor 102, which in turn receives power from the mounting surface (e.g., truck or platform), which control signals that can be wirelessly received at the PCBs.

In some cases, the flow device assembly 100 can receive power through a power connector (e.g., DC power). In some cases, the power connector can be disposed on a back surface of the monitor 102. In some cases, the power connector can also provide communications (e.g., hard-wired communications). In some cases, the power connector only facilitates a power connection, and communications are enabled through a wireless control.

FIG. 2C is a left side view of the monitor 102, showing the inlet 204, outlet 206, and handles 210, 212. FIG. 2C shows an arrow 205 to indicate the possible zenith adjustment that the outlet 206 can undergo. FIG. 2C also illustrates the locations of two of the motors, disposed in regions 218 interior to the body 201.

FIG. 3A is an exploded view of the monitor 102, according to one embodiment. The monitor 102 can include a monitor body 302, an outlet arm 304, an elevation drive assembly 306, and a cover 308. The monitor body 302, outlet arm 304 and cover 308 can together define the housing 201 (FIG. 2A) of the monitor 102. The outlet arm 304 can have a first side coupled to a side of the monitor body 302. A second side of the outlet arm 304 that is opposite the first side can couple to a first side of the elevation drive assembly 306, and the cover 308 (e.g., elevation drive assembly cover) can couple to a second side of the elevation drive assembly 306 that is opposite the first side. The cover 308 facilitates encasing a motor, gears, and/or electrical circuitry that may form a part of the elevation drive assembly 306.

FIGS. 3B-3C show the monitor body 302 having a shell that forms part of the housing 201. As shown in FIG. 3B, a bottom portion 316 of the monitor body 302 includes the inlet 204. The monitor body 302 can include a motor 320 (e.g., a rotation motor) to facilitate a rotation of the monitor body 302 about the vertical axis 214, as indicated by the arrow 324.

In some cases, the motor 320 can be a stepper motor, which can advantageously employ the complex signal capacity of electrical connections at a power connector or of a wireless control. A stepper motor, as compared to a DC motor, moves in a series of steps, allowing one to determine the motor position at a specified time. The stepper motor can electrically connect to a PCB, which can be external to the stepper motor. In some cases, one PCB can be implemented to control a plurality of stepper motors. As described herein, because the monitor 102 can be fabricated to be compact with a majority of the electrical wiring disposed internal to the housing 201 of the monitor 102, a majority of the electrical wiring between an individual stepper motor and the PCB can be housed within the housing 201. In some cases, the monitor body 302 can include an encoder 330 (e.g., an absolute encoder), which can provide feedback regarding the position and speed of the motor 320, allowing for improved control and accuracy of the motor 320. In some cases, the motor 320 can be a servo motor or a DC motor. In cases where a servo motor is implemented, the individual servo motor can have a PCB internal to the motor, possibly minimizing the amount of wiring as compared with a stepper motor configuration.

FIG. 3C shows a top view cross section of the monitor body 302 taken along the lines 3C-3C in FIG. 3B. As shown in FIG. 3C, the motor 320 can be mechanically coupled to a rotation gear 326 (e.g., a first stage rotation gear) to enable a non-manual or motorized operation of the rotation gear stage 326. In some cases, the rotation gear stage 326 can be a worm gear. For example, the worm gear can be used with a worm wheel, such that the worm gear (e.g., a gear reducer) has a ratio in a range between about 20:1 and 80:1, such as about 60:1. In some cases, the motor 320 operates with a single stage gear reduction. In some cases, the rotation of the monitor body 302 can be manually accomplished by rotating the rotation handle 210 coupled to a first rotary shaft 337. In some arrangements, monitor body 302 is capable of a full 360° rotation about the axis 322 (FIG. 3B). In other arrangements, the monitor can rotate approximately 359° before reversing rotation. In still other arrangements, the rotation can be limited, e.g. to 270° or 180°, to prevent spray in one direction.

The monitor body 302 can include a fluid pathway 332 (e.g., FIGS. 3B, 3H) that is separate or isolated from electronic components within the monitor 102. The fluid pathway 332 can extend from the inlet 204 and have a varying cross-section through the monitor body 302 and allow for a fluid (e.g., a liquid such as water or foam for firefighting applications, de-icing fluid, etc.) to traverse the length of the fluid pathway 332. For example, the fluid pathway 332 can have a first cross-section at the inlet 204 having an inner diameter d₁ and a second cross-section at a connecting portion 334 of the monitor body 302 having an inner diameter d₂, where d₂ is greater than d₁. In some cases, d₁ can be in a range between approximately 2″ and 3″ and d₂ can be in a range between approximately 4.5″ and 5.5″.

FIG. 3D illustrates the outlet arm 304 of the monitor 102 having a side 336 that can couple (e.g., connect or attach) to the connecting portion 334 of the monitor body 302 (FIG. 3B). The outlet arm 304 can include a shell or body 335 that partially defines the monitor housing 201 (FIG. 2A). The body 335 can be made from a material that is the same as the material of the shell of the monitor body 302. Fluid can flow from the monitor body 302 into the outlet arm 304, in which the flow path turns about 90° and narrows after the turn and before exiting the outlet arm 304 through the outlet 206. The outlet 206 has a diameter of d₃. In some cases, the diameter of the outlet 206 is less than the diameter d₁ of the inlet 204. In some cases, where the diameter d₁ can be in a range of approximately 2″ and 3″, the corresponding outlet diameter d₃ can be in a range between approximately 1.3″ and 2.3″.

FIG. 3E shows the outlet 206 that can include a rotatable element 339 (e.g., swivel element) including the threaded portion 208 (or other connection mechanism), which allows for the attachment of one or more additional downstream components to the outlet arm 304. For example, the one or more additional components can include the integrated adjustable restriction and shut-off element 104, the stream straightener component 106, and/or the nozzle 108 as described with respect to FIG. 1, which can attach to the outlet 206 through the threaded portion 208. An adjustment component such as a crank handle (or hand crank) and/or a motor 338 can be included in the outlet arm 304 to enable an adjustment of the orientation of at least the outlet 206 about an outlet axis 340, which is generally parallel to the flow path at the outlet 206, as indicated by the arrow 342. In some embodiments, adjusting the orientation of the outlet 206 results in the rotation of the rotatable element 339, which can enable the rotation of the one or more additional downstream components coupled to the outlet 206. In some cases, those components include a nozzle having an orifice that is not radially or otherwise symmetrical in a plane transverse to the flow direction. For example, the illustrated nozzle 108 in FIGS. 1 and 8A-8E has a rectangular outlet that enables a fan-shaped stream of fluid to exit the nozzle. In embodiments implementing the nozzle 108 with a fan-shaped stream, adjusting the orientation of the outlet 206 and thereby the attached nozzle, facilitates rotating the orientation of a fan-shaped stream of fluid expelled from the outlet arm 304. In some embodiments, the nozzle is adjustable to produce different angular orientations of the fan-shaped stream, and thus different degrees of fluid dispersion. In some cases, the orientation can be adjusted between approximately 0° and 90°. In some cases, the orientation can be adjusted between approximately 0° and 135°, or between approximately 0° and 360°.

As shown in the semi-transparent top perspective view of FIG. 3E, in some cases, the motor 338 is located closer to a second side 344 than the first side 336 of the outlet arm 304, where the second side 344 is opposite the first side 336. In some cases, the motor 338 can be a stepper motor. In some cases, the motor 338 can be a servo motor or a DC motor. The motor 338 can be mechanically coupled to a first orientation gear stage 346 (e.g., a rotation gear first stage) to enable a non-manual or motorized operation of the orientation gear stage 346. In some cases, the first orientation gear stage 346 can be a worm gear, having a gear ratio in a range between about 20:1 and 80:1. For example, the gear ratio can be about 40:1 or about 60:1. The motor 338 and the first orientation gear stage 346 can be coupled to a second orientation gear stage 348 (e.g., the first orientation gear stage 346 and the second orientation gear stage 348 can be mechanically coupled via a third rotary shaft 349). The second orientation gear stage 348 may be a spur gear. For example, the second orientation gear stage 348 can include a spur gear having a gear ratio in a range between about 1:1 and 6:1, such as about 3.44:1.

FIG. 3F illustrates the elevation drive assembly 306, according to one embodiment. The elevation drive assembly 306 includes a shell or body 350 that facilitates the coupling of a first side 352 of the elevation drive assembly 306 to the second side 344 of the outlet arm 304. The body 350 further includes a drive mounting plate 354 to further support the elevation drive assembly 306 on the monitor body 201 (FIG. 3B). The elevation drive assembly 306 includes a motor 356 (e.g., an elevation motor) to facilitate an adjustment of the elevation (e.g., zenith) of the outlet 206 by rotating the outlet arm 304 (and thus the outlet 206) about a horizontal axis 358, as indicated by the arrow 205. In some arrangements, the elevation can be adjusted between a range of angles. In some cases, the elevation can be adjusted within a total range of 180°. In some cases, the elevation can be adjusted between −45° and 90°, for a 135° range of motion, where 90° corresponds to the vertical direction parallel to an axis extending through the inlet 204 and 0° corresponds to the horizontal direction.

In some cases, the motor 356 can be a stepper motor. In some cases, the motor 356 can be a servo motor or a DC motor. In some cases, the elevation drive assembly 306 can include an encoder 364 (e.g., an absolute encoder), which can provide feedback regarding the position and speed of the motor 356, allowing for improved control and accuracy of the motor 356. FIG. 3F additionally shows that the elevation drive assembly 306 can include electronic circuitry 351. The electronic circuitry 351 may include peripheral motor drivers to operate one or more motors of the downstream components that can be implemented with the monitor 102.

As shown in FIG. 3G, the motor 356 can be mechanically coupled to an elevation gear stage 362 via a rotary shaft 365 to enable a non-manual operation of the elevation gear stage 362. In some cases, the elevation gear stage 362 can be a worm gear configured to operate with a worm wheel 363 of the outlet arm 304, illustrated in FIGS. 3D and 3E. In some cases, the elevation gear stage 362 (e.g., worm gear) can have a gear ratio in a range between about 20:1 and 80:1, such as about 60:1. In some cases, the adjustment of the elevation can be manually operated by rotating the elevation handle 212 coupled to a second rotary shaft 365. In some cases, the motor 356 operates with a single stage gear reduction (e.g., elevation gear stage 362).

In some embodiments, one or more of the gears (e.g., 326, 346, 348, 362) are modular components. The one or more gears can be coupled to (e.g., bolted to) the device rather than being machined into the monitor, such that they can be easily serviced or replaced as needed.

In some embodiments, the circuit board 366 can be included within the elevation drive assembly 306. In some cases, the circuit board 366 can be a printed circuit board array, PCBA. The PCBA can facilitate central and remote control of electrical components within the monitor 102. For example, a PCBA can be implemented within the monitor 102 for controlling one or more of the motors 320, 338, 356. In some embodiments, the circuit board 366 can be in communication with an independent remote control or a control panel of a truck. In some cases, the control panel can communicate with the circuit board 366 through hard wires or wirelessly. In some cases, the remote control is hard-wired or battery-operated. In some cases, the monitor 102 can receive power from the mounting surface (e.g., truck or platform), which can control signals that can be wirelessly received at the PCBA, and/or a separate remote-control device can be provided for the monitor 102 and its attached components.

FIG. 3H is a rear elevational cross section of the monitor 102 taken along the lines 3H-3H of FIG. 2C. The interior of the monitor 102 can be separated into a first region 368 of the monitor 102 (e.g., left side of this rear view) that includes the fluid pathway 332 (e.g., water way) and a second region 370 of the monitor 102 (e.g., right side of this rear view) that includes a plurality of devices capable of adjusting at least one of a rotation, elevation, and an orientation of the monitor 102, as described herein. The fluid (e.g., water) can enter the first monitor region 368 through the inlet 204 and travel through the fluid pathway 332 towards the outlet 206.

As shown in FIG. 3H, the fluid pathway 332 can include a plurality of bends that facilitate transitioning the directional flow of a fluid in the fluid pathway 332 from an inlet direction at the inlet 204 to an outlet direction at the outlet 206. In some cases, the inlet direction can be a vertical direction parallel to the axis 214, and the outlet direction can be a non-vertical direction. The outlet direction can change in operation as the elevation (zenith angle) of the outlet 206 changes. For purposes of illustration, assume that the outlet direction is approximately 90° (e.g., between 85° and 95°) relative to the first direction. The fluid pathway 332 follows multiple bends that take the flow through significantly more than 90° (regardless of the zenith angle) in direction changes in order to reduce reaction forces from the direction change. For example, the fluid pathway 332 can include a first bend 372, a second bend 374, a third bend 376, and a fourth bend 378. The first bend 372 redirects the fluid from traveling in the inlet direction (up in the illustrated embodiment) to a second direction (toward the left side of FIG. 3H) that is approximately 45° (e.g., between 40° and 50°) relative to the first direction. This angle may be referred to as a bend angle or a first bend angle hereinafter, though it will be understood that the change in the direction can be gradual through a curved path as shown, rather than sudden with a sharp corner. The second bend 374 redirects the fluid traveling in the second direction to a third direction (up in the illustrated embodiment) that is approximately 45° (e.g., between 40° and 50°) (e.g., second bend angle) relative to the second direction. The third bend 376 redirects the fluid traveling in the third direction to a fourth direction (right in the view of FIG. 3H) that is approximately 90°(e.g., between 85° and 95°) (e.g., third bend angle) relative to the third direction. And the fourth bend 378 redirects the fluid traveling in the fourth direction to a fifth direction (e.g., the outlet direction direction) (approximately into the page in the view of FIG. 3H) that is approximately 90° (e.g., between 85° and 95°) (e.g., fourth bend angle) in the horizontal dimension relative to the fourth direction, and can also include a turn in a vertical dimension depending upon the zenith angle of the outlet 206, at which point the fluid can exit the outlet 206. The skilled artisan will appreciate that the exact number of bends and angles of each bend is not critical. However, the lengthened path and total number of direction changes along the path can reduce reaction and turbulence while reorienting the flow toward the outlet 206. The total bends or turns may result in more than 180° of turns in the flow path, and in the illustrated embodiment total about 270° in turns for the approximate resultant 90° effective change in direction between the inlet 204 and the outlet 206.

The second region 370 of the monitor 102 in FIG. 3H is separate from and sealed from the fluid flow pathway 332 of the first region 368 to prevent moisture from entering and interfering with electrical components that may be included in the second region 370. In some cases, the second region 370 can include a plurality of motors to facilitate a rotational adjustment of the monitor 102 about various axes. Such motors may correspond to the location of the rotation shafts that are depicted in FIG. 3H. For example, the first rotary shaft 337 may correspond to the location of a motor to adjust an azimuthal rotation of the monitor 102. The second rotary shaft 365 may correspond to the location of a motor to adjust a zenith rotation of the outlet arm 304, and the third rotary shaft 349 may correspond to the location of a motor to adjust an orientation at the outlet 206 of the monitor 102. Arranging the rotary shafts 337, 365, 349 for the motorized adjustments to be roughly parallel to one another permits back-up manual handles 210, 212 to be grouped on one side of the monitor 102, as shown in FIG. 2B. While not illustrated, in some embodiments, an additional handle can be added for the third rotary shaft 349 to adjust the orientation of the outlet 206 if the power, corresponding motor or electronics fail. Having the manual handles 210, 212 on the same side of the monitor 102 simplifies access by users so they need not reach multiple sides of the monitor, which could be difficult depending on how the device is mounted. However, the manual handles 210, 212 need not be on the same side of the monitor 102.

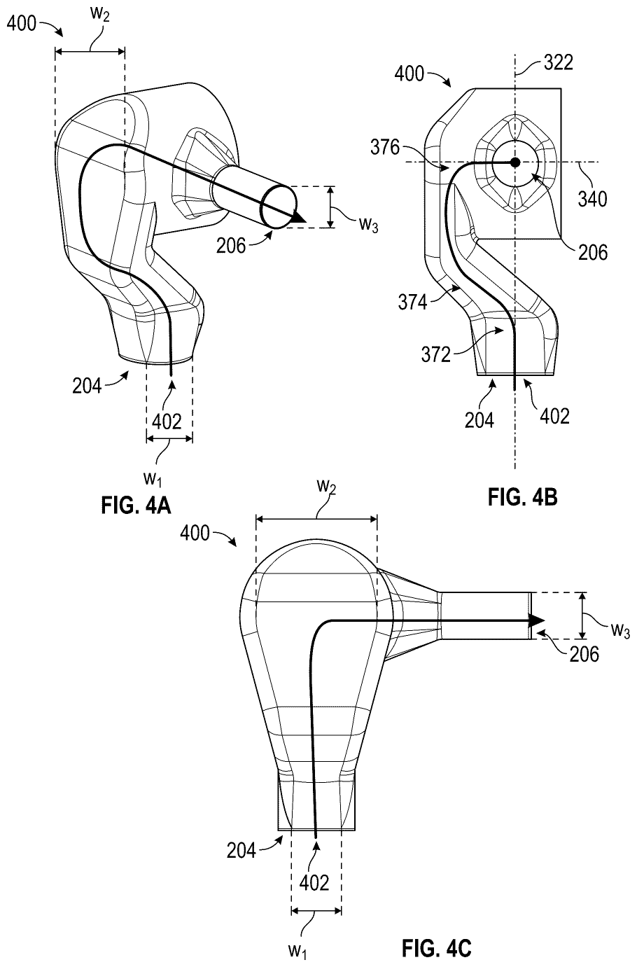

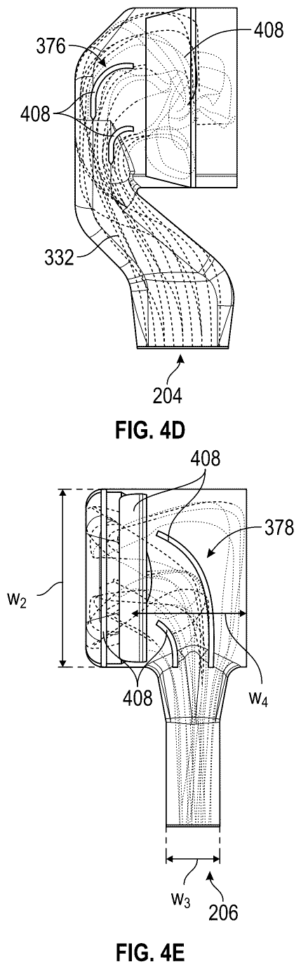

FIGS. 4A-4E are simplified schematics of a portion of a monitor 400 including simplified and simulated views of the fluid flow 402 in the monitor 400. The monitor 400 depicted is substantially similar to the monitor 102 described above, except that the fluid pathway is disposed on the opposite side of the monitor 400 (as compared to the fluid pathway 332 in monitor 102 in FIGS. 1-3H). FIG. 4A provides an overall view of the fluid flow 402 with respect to a perspective front view of a portion of the monitor 400. FIG. 4B is a front elevational view showing the first three bends (e.g., first bend 372, second bend 374, third bend 376) of the fluid flow 402 in a vertical plane. The fourth bend 378 turns out of the paper in the view of FIG. 4B and can be best seen in the horizontal cross section of FIG. 4E. These bends can have the same angular values as described for the same-numbered bends with respect to FIG. 3H.

Further, it can be seen from FIGS. 4A-4C that as the fluid flow 402 traverses the monitor 400, the cross-sectional areas (e.g., transverse cross-sectional areas) or maximum dimension orthogonal to the flow (e.g., width) can be modulated to reduce fluid velocity in the turns, thus reducing reaction force and turbulence in a more compact space. Widening the flow path can help keep the overall profile of the monitor 102 (and the flow device assembly 100) compact, which can correspond to a lighter-weight monitor. For example, the flow path can have a maximum dimension w₁ proximate to the inlet 204. As the fluid flows through the first bend 372, the maximum dimension orthogonal to the flow can increase until the fluid reaches an intermediate point like the fourth bend 378 (see for example the dimension w₂ in FIGS. 4A and 4C), at which point the maximum dimension orthogonal to the flow can undergo narrowing until it reaches a maximum dimension orthogonal to the flow of w₃. In the illustrated embodiment, the outlet 206 is smaller than the inlet, such that w₃<w₁<w₂. In some cases, w₁ can be between about 1.5 and 1.7 times w₃, and w₁ can be between about 0.3 and 0.5 times w₂. For example, w₁ is about 2.5″, w₂ is about 6″, and w₃ is about 1.5″. In some cases, w₁ can correspond to d₁ and w₃ can correspond to d₃. Implementing large cross-sectional areas (as indicated by the dimensions w₂ and w₄ in FIG. 4E) where the flow is to make sharp turns (e.g., 90° turns) allows for a widened and thus slowed flow path through the turns. These turns can consequently accomplish a more compact overall monitor for a given pressure drop between inlet and outlet and a desired low level of reaction and turbulence. After the turns, or in the midst of the last turn, the path again narrows to feed a smaller outlet 206. In some embodiments, and as shown in FIG. 4B, the outlet 206 is centered on both the azimuth rotation axis 322 and the zenith rotation axis 340. Centering the outlet 206 on both of the rotation axes 322, 340 can prevent an unintentional rotation due to nozzle force.

FIGS. 4D-4E show that in some cases, the fluid pathway 332 can include various structures to help facilitate fluid flow. For example, one or more internal vanes 408 may be included at the 90° bend locations. The internal vanes 408 compartmentalize the flow into multiple fluid streams within the broadened flow path at more extreme bends (e.g., bends 376, 378) and can help to reduce turbulence introduced by these turns. As fluid travels from the inlet 204 to the outlet 206 through the fluid pathway 332, a pressure drop will occur. Inclusion of the internal vanes can reduce this pressure drop in the fluid flow. In some cases, the internal vanes minimize the pressure drop in the fluid flow between the inlet 204 and the outlet 206. In some cases, the addition of internal vanes results in the pressure drop, with the pressure being reduced by a factor in a range of at least about 1.5 and about 2.5, or in a range of at least about 2.5 and about 5. For example, in some cases, the pressure drop can be reduced by a factor of about 3. In some cases, the addition of internal vanes results in the pressure drop being reduced by a factor of at least about 2. In some cases, these internal vanes can change the direction of the fluid flow and enable the stream of fluid to optimally exit the monitor. In some embodiments, additional internal vanes can be included in the flow path. For example, one or more internal vanes may be included in the flow path region proximate the inlet.

Although a monitor 102, 400 has been described herein as having a flow path with a varying cross-section and one or more motors, in some cases, a monitor can have a different flow path and one or more motors. For example, a monitor can include a flow path in which the cross-sections along the flow path do not vary substantially between the inlet and the outlet. Such a monitor can further include a motor to allow an adjustment of the orientation of at least the outlet about an outlet axis (similar to the embodiment in FIG. 3E). In some cases, the flow path can be similar or the same as conventional flow paths or other flow paths known in the art and terminate at an outlet that is couple to a motor, such that the motor enables adjustment of an orientation of the output.

### Additional Components

FIGS. 5A-5D show the restriction and shut-off element 104 that can be included in a flow device assembly 100. FIG. 5A is a perspective left and front view of the restriction and shut-off element 104, including a restriction inlet 502, a restriction outlet 504, and a motor cover 505 housing a motor 506 (see FIG. 5B). The motor 506 in coordination with a series of gears can provide a single mechanism for operating both the shutting on/off the fluid flow and the restriction of the fluid flow through the restriction and shut-off element 104. In some cases, the restriction and shut-off element 104 can include one or more handles 503 (e.g., lever handles) to facilitate manual operation of the restriction and shut-off element 104.

FIG. 5B is a cross-sectional side view of the restriction and shut-off element 104, which can include at least the motor 506 (the motor cover is omitted in this view), a shut-off element (e.g., a ball valve 508) and a flow restriction element 510. In some embodiments, the shut-off element may be a component that includes an opening that can be aligned or misaligned with respect to a flow path, such that alignment with the flow path results in “turning on” the flow and misalignment with the flow path results in “turning off” the flow. In some cases, the shut-off element is a quarter-turn valve. In some cases, the shut-off element is a multiple-turn valve. The embodiment of FIGS. 5A-5I implements a ball valve 508, but the shut-off element is not limited to ball valves. For example, the shut-off element could include a butterfly valve, or a gate valve. In some cases, the shut-off element can be operated using a solenoid coil, instead of a motor (e.g., solenoid-operated butterfly valve versus motorized butterfly valve).

FIG. 5C is one view of the ball valve 508 including an opening 526. In some embodiments, the ball valve 508 is an integrated ball valve. In some embodiments, the ball valve 508 is a trunnion ball valve or a quarter-turn ball valve, etc. In some cases, the ball valve 508 can include pin locations 501 (and pins 516 as shown in FIG. 5B) which allow the ball valve 508 to be coupled to the motor 506 to facilitate a quarter turn (e.g., a 90° turn) of the ball valve 508 relative to the restriction outlet 504.

FIG. 5D shows elements of the flow restriction element 510, which can also be referred to as an adjustable flow restriction element or a variable flow restriction element. The flow restriction element 510 of the restriction and shut-off element 104 may include a first component 512 having first protrusions (e.g., first lobes 528) extending into the flow path and a second component 514 having second protrusions (e.g., second lobes 530) extending into the flow path. Although three first lobes 528 and three second lobes 530 are shown, in some cases, a greater or lesser number of lobes 528, 530 may be included. In some embodiments, the first component 512 is fixed or stationary relative to the restriction and shut-off element 104, and the second component 514 is movable, as described with respect to FIGS. 5G-5I. In some embodiments, at least one of the first component 512 and the second component 514 is movable or rotatable relative to the restriction and shut-off element 104. When the first lobes 528 are overlaid and aligned with the second lobes 530, the cross-sectional area of the fluid flow path through the first and second components 512, 514 is at a maximum (e.g., FIG. 5I), and the pressure drop across the flow restriction element 510 is at a minimum. When the first lobes 528 of the first component 512 are fully misaligned with respect to the second lobes 530 of the second component 514, the cross-sectional area of the fluid flow path through the first and second components 512, 514 is restricted and at a minimum (e.g., FIG. 5H), and the pressure drop across the flow restriction element 510 is at a maximum.

In some embodiments, instead of lobes, the first component 512 and second component 514 can include elliptical openings, such that rotation of a first elliptical opening relative to a second elliptical opening can result in an adjustment of the fluid flow. For example, if the first elliptical opening is overlaid and aligned with the second elliptical opening, the cross-sectional area of the fluid flow path may be at a maximum and pressure drop is at a minimum, whereas if the first elliptical opening is rotated to have its major axis perpendicular to the major axis of the second elliptical opening, then the cross-sectional area of the fluid flow path may be at a minimum (e.g., the restriction of the fluid flow and pressure drop is maximized).

FIG. 5E shows a side elevation view of the gears that can be included in the restriction and shut-off element 104. In some embodiments, the motor 506 is coupled to the motor gear 520; the motor gear 520 is coupled to the ring gear 522; and the ring gear 522 is coupled to the ball valve gear 524. In the illustrated embodiment, the ball valve gear 524 comprises a partial spur-gear. The partial spur-gear includes teeth on a portion of the gear and lacks teeth on the remaining portion of the gear. The motor 506 turns the motor gear 520, driving the rotation of the ring gear 522, and driving the rotation of the ball valve gear 524 when the section with teeth is engaged with the ring gear 522. The ball valve gear 524 is attached to the ball valve 508 through a trunnion 507. Thus, the motor 506, through the gears 520, 522, 524 can facilitate a rotation of the ball valve 508. In some embodiments, the ring gear 522 will rotate approximately 60°, which will correspond to a 90° rotation of the ball valve 508, allowing the ball valve 508 to change from a closed condition (e.g., the opening 526 and the flow path are misaligned) to an open condition (e.g., the opening 526 and flow path are aligned). The second component 514 of the flow restriction element 510 is also coupled (e.g., attached or fixed) to the ring gear 522, such that the second component 514 will move during the rotation of the ball valve 508. The first and second lobes 528, 530 are oriented such that once the ball valve 508 reaches a fully opened position relative to the flow path, the flow restriction element 510 is in its most restricted position (e.g., the first lobes 528 and the second lobes 530 are misaligned relative to each other as shown in FIG. 5H). Accordingly, when the flow is first turned on, back-pressure in the monitor 102 and pressure drop across the flow restriction element 510 are at their maximums, although it will be recognized that the opposite arrangement can be selected to instead minimize restriction and pressure drop upon turning the flow on. Because the ball valve gear 524 includes a portion that is lacking teeth, once the ball valve 508 is in its fully opened position, the ring gear 522 can continue to rotate without resulting in further rotation of the ball valve 508. This continued rotation of the ring gear 522 enables an additional approximately 60° of rotation of the second component 514, which corresponds to the first lobes 528 and the second lobes 530 to being aligned. Thus, the additional rotation once the ball valve 508 is in its fully opened position, results in the full opening of the flow restriction element 510 within the restriction and shut-off element 104.

FIG. 5F shows the ball valve 508, first component 512, and second component 514 isolated from the other parts of the restriction and shut-off element 104. It demonstrates that as the ball valve 508 is rotated about the axis 532, the second component 514 is rotated about the axis 534, where axis 534 is perpendicular to the axis 532. In some cases, instead of the second component 514 rotating, the first component 512 can be rotated. In some cases, both the first component 512 and the second component 514 can be rotated about the axis 534.

FIGS. 5G-5I are partial front elevation views of three different states of the restriction and shut-off element 104. In FIG. 5G, the restriction and shut-off element 104 is in a fully closed (e.g., off) state. The solid side of the ball valve 508 is in the view of the flow path, and no fluid can come through the restriction and shut-off element 104. In FIG. 5H, the restriction and shut-off element 104 is in an open and restricted state. The ball valve 508 has been rotated such that the opening 526 is in the view of the flow path. At the end of the ball valve 508 rotation, the second component 514 is in a restricted flow state. In FIG. 5I, the restriction and shut-off element 104 is in an open and minimal restriction state. To reach this state, the ball valve gear 524 includes portions lacking teeth so that any additional rotation of the ring gear 522 will only facilitate additional rotation of the second component 514 and not the ball valve 508. As such, the second component 514 can be further rotated until its second lobes 530 are overlaid and aligned with the first lobes 528 of the first component 512. In this position, the flow restriction element 510 is in its least restrictive state (e.g., allows for minimal pressure drop across the restriction and shut-off element 104).

The combination of the motor 506 with the motor gear 520, ring gear 522, and ball valve gear 524 allows for a single mechanism to control both fluid flow restriction and the on/off state of the fluid flow. This combination is beneficial in that it reduces the number of components needed for these two separate functions and allows for the features to readily be incorporated into a single downstream component with a single motor. In some embodiments, more than three gears may be implemented. In some embodiments, no motor is included within the restriction and shut-off element 104. Instead, in such embodiments, one or more levers 503 may be included to enable manual adjustments of the various states of the restriction and shut-off element 104. In the illustrated embodiment, the restriction and shut-off element 104 includes both a motor 506 and the one or more levers 503, which allows a user the option to operate the restriction and shut-off element 104 either automatically/electronically or manually. In some cases, manual operation can be used where the motor or gears are inoperable or malfunctioning. In some embodiments, more than one motor may be implemented.

While a particular mechanism is illustrated for providing a common control mechanism for both the relative restriction of the flow restriction element 510 and the shut-off element, the skilled artisan will appreciate that other mechanisms can provide such common control. The common control mechanism can significantly reduce weight of the downstream components for the flow device assembly 100, and in particular avoid the need for a second motor to control both variable restriction and shut-off elements.

FIGS. 6A and 6B show a stream straightener component 106 that can be included in a flow device assembly 100. The stream straightener component 106 can reduce turbulence in the flow of a fluid traveling exiting at least a monitor 102 in a flow device assembly 100. For example, in some cases where a restriction and shut-off element 104 is implemented with the monitor 102 for flow constriction, the fluid exiting the restriction and shut-off element 104 may be turbulent. Even without the restriction and shut-off element 104, the stream straightener component 106 may be implemented to reduce turbulence from the monitor 102.

FIG. 6A is a perspective view of the stream straightener component 106 having a straightener inlet 602 and a straightener outlet 604. FIG. 6B is a semi-transparent perspective view of the stream straightener component 106 of FIG. 6A. Two stream straightener elements 606 can be seen in the stream straightener component 106. One stream straightener element 606 can be disposed proximate to or at the straightener inlet 602 (e.g., closer to the straightener inlet 602 than the straightener outlet 604) and another stream straightener element 606 can be disposed proximate to or at the straightener outlet 604 (e.g., disposed closer to the straightener outlet 604 than to the straightener inlet 602). In some embodiments, the stream straightener component 106 can include one stream straightener element 606. In some embodiments, the stream straightener component 106 can include more than two stream straightener elements 606. The stream straightener elements 606 can include vanes in various configurations. For example, as shown in FIG. 6B, the straightener element 606 can include a plurality of radial vanes 608 circularly arranged about a cylindrical section along the central axis of the straightener element 606. For example, the straightener element 606 can be a fin-type element. The plurality of vanes 608 can be structured with leading edge tapering and can slope in a funnel shape from the inlet side to the central cylinder as they extend radially inward, which is slightly downstream from the leading edge of the straightener element 606, to minimize disturbance and streamline fluid flow entering the straightener element 606. On the outlet side of the straightener element 606, the trailing edges of the plurality of vanes 608 can be coplanar, and can also be tapered. In some embodiments, the plurality of vanes can include other shapes and configurations. For example, the plurality of vanes can form a plurality of tubular-like elements, such as a honeycomb structure.

In some embodiments, the stream straightener component 106 can include one or more sensors or one or more measurement devices to measure a flow rate of a fluid traversing the stream straightener component 106. In some cases, the stream straightener component 106 can include a signal emitter and a signal sensor to determine a flow rate. In some embodiments, the emitter and sensor can both be transducers 610 (e.g., ultrasonic transducers). In the embodiment implementing ultrasonic transducers, a first transducer (e.g., an emitter) can emit a high frequency signal. The high frequency signal can be in a range between approximately 1 MHz and 2 MHz. A second transducer (e.g., a receiver or sensor) can receive this high frequency signal. It will be understood that emitters and sensors operating at other frequencies could be used. A microprocessor (not shown) can then measure the time difference between the sent and the received signal, which is proportional to flow velocity and thus volume flow rate. In some embodiments, a pressure measurement device can additionally or instead be integrated into the stream straightener component 106 (e.g., an internal pressure measurement element). For example, the stream straightener component 106 can include an internal pitot tube. In some cases, the stream straightener can include a venturi tube.

FIGS. 7A and 7B show different positions of the transducers 610 relative to the stream straightener component 106. In some embodiments, the transducers 610 can be oriented such that the emitter is disposed opposite the receiver (FIG. 7A). In this case, a signal 612 emitted from the emitter is directed to the receiver. In some embodiments, the transducers 610 can be oriented such that the emitter is disposed on a same side as the receiver (FIG. 7B). In this case, a signal 612a emitted from the emitter is directed to and reflected off of an internal side of the stream straightener component 106. The reflected signal 612b is then received by the receiver.

FIG. 8A is a perspective view of the nozzle 108 (e.g., an electronic nozzle). The nozzle 108 can be similar in design or concept as the nozzles described in U.S. Patent Publications Nos. 2024/0198363 A1 (Sethi et al.) and 2022/0296943 A1 (Sethi et al.), the disclosures of each of which are incorporated by reference herein. The nozzle 108 is configured to operate with a flow device assembly 100, including at least the monitor 102, as opposed to a hose or other handheld application. The nozzle 108 can include adjustable arms that can be pivoted or adjusted towards or away from a flow path, which can correspond to a narrowing or widening of the fluid spray shape exiting the nozzle 108. In some cases, the nozzle 108 can include two movable arms, where the arms are on opposite sides of the flow path. In some cases, the two movable arms can facilitate a vertical squeezing of the fluid (e.g., the arms are disposed at a top and bottom position relative to a flow path, such as shown in FIGS. 8A-8F), causing a widening of the fluid spray. In other cases, such as the nozzles of the above incorporated patent publications, the two movable arms can define the angle of outer walls (e.g., the arms are disposed at a left and right side relative to a flow path), and thereby define the angle of the effluent spray in the horizontal dimension. In either case, the spray can be controlled between a relatively wide fan-shape and a relatively narrow and confined straight flow. It will be understood that “horizontal” in the present description is relative to the orientation of FIGS. 8A-8F, and that this orientation can be adjusted by a motor within the monitor, as described above with respect to FIGS. 3D-3E and orientation motor 338. In some cases, the two movable arms can be adjusted manually or electrically.

As shown in FIG. 8A, the nozzle 108 includes a nozzle inlet 802 and a nozzle outlet 804. The nozzle 108 can further include a nozzle body 801, a nozzle shell 803, and an actuator 805. The nozzle 108 can directly connect to the monitor 102, or to the restriction and shut-off element 104, or to the stream straightener component 106 at the nozzle inlet 802. In some cases, the nozzle inlet 802 can include a threaded portion to facilitate direct attachment of the nozzle 108 to the monitor or to intervening additional components that may already be coupled to the monitor 102, such as the integrated adjustable restriction and shut-off valve element 104 or the stream straightener component. The nozzle outlet 804 includes an orifice 806 (e.g., nozzle orifice) through which a fluid is expelled from the flow device assembly 100. In some embodiments, the orifice 806 is not radially symmetrical and in the illustrated embodiment comprises a rectangular shape such that the fluid spray comprises a fan shape. In some embodiments, the orifice 806 can comprise any other suitable shape (e.g., rectangle, circle, etc.).

In some embodiments, the nozzle 108 can be an adjustable nozzle. In some cases, the adjustable nozzle facilitates an adjustment of the cross-sectional area or shape of the orifice 806. In some embodiments, the nozzle 108 can include an adjustable mechanism (e.g., spray shape-adjusting assembly). For example, the nozzle 108 can include an actuator 805 (e.g., a linear actuator) that can slide the nozzle shell 803 relative to the nozzle body 801. As the actuator 805 moves the nozzle shell 803, the pair of arms 808 (e.g., adjustment arms), are simultaneously moved or adjusted, such that each of the arms 808 can move or pivot towards or away from the fluid flow, thereby adjusting the effective cross-sectional area and angle of the outer walls of the orifice 806, and consequently the dimensions of the fluid spray that exits the nozzle 108. In some cases, the nozzle 108 can be operated manually or electrically. For example, the nozzle shell 803 can be moved manually relative to the nozzle body 801 to adjust the arms 808.

FIG. 8B is an enlarged partial side cross-sectional view taken along lines 8B-8B in FIG. 8A, illustrating the pivoting mechanism for the arms 808. The nozzle body 801 has a structure including two body grooves 807 that are each fabricated to couple to first rounded arm portions 809. Each of the two first rounded arm portions 809 is disposed in its respective body groove 807 and can move or pivot with respect to the body groove 807. The nozzle shell 803 shown in FIG. 8A is coupled to a nozzle shell face 811, which includes two sloped protrusions 813, each having a sloped surface 815. The sloped surface 815 is in contact (e.g., engages) with a second rounded arm portion 817. When the nozzle shell 803 is linearly moved over the nozzle body 801 to a position further from the downstream end of the nozzle 108 (e.g., moved towards the left side of the page), the sloped surface 815 of each of the two sloped protrusions 813 also moves further from the downstream end of the nozzle 108. The second rounded arm portion 817 becomes positioned closer to the outwardly facing front side of the nozzle shell face 811, and the first rounded arm portion 809 simultaneously pivots within a body groove 807 to bring the ends of the arms 808 closest to the second rounded arm portions 817 closer together. This adjustment results in a fan-shaped stream as depicted in FIGS. 8E-8F. When the nozzle shell 803 is linearly moved over the nozzle body 801 to a position closer to the downstream end of the nozzle 108 (e.g., away from the nozzle body 801 or towards the right side of the page), the sloped surface 815 of each of the two sloped protrusions 813 also moves closer to the downstream end of the nozzle 108. The second rounded arm portion 817 becomes positioned further away from the outwardly facing front side of the nozzle shell face 811, and the first rounded arm portions 809 simultaneously pivots within a body groove 807 to push the ends of the arms 808 closest to the second rounded arm portion 817 further apart. This adjustment results in a solid or tight stream as depicted in FIGS. 8C-8D.

In FIG. 8C the side cross-section of the nozzle 108 shows that the nozzle shell 803 can linearly slide over the nozzle body 801 to a position closer to the downstream end of the nozzle 108. As described above with FIG. 8B, linearly sliding the nozzle shell face 811 away from the nozzle body 801 causes the arms 808 to pivot outwardly. This movement results in the arms 808 being moved into an “open” position, resulting in the emission of a solid and/or tight pattern stream. In some cases, the stream is a straight stream. In some cases, a straight stream configuration or pattern can be the initial stream configuration or pattern for the nozzle 108, such that the motor or manual adjustment mechanism is engaged before a widened fan-shaped spray can be obtained. A straight stream pattern may be understood to mean that the fluid exiting the nozzle is discharged as an approximately columnar shape or an approximately straight and linear shape. In some cases, the initial stream configuration can include a least spread effluent or discharge or a most confined spray configuration relative to other spray configurations that the nozzle is capable of discharging. In some cases, the position of the arms 808 can be remembered, such that the nozzle 108 can produce a stream of a desired pattern from one operation to another, later operation. In some cases, the position of the arms 808 can be automatically returned to a position corresponding to the initial stream configuration (e.g., straight stream configuration), for example either on start-up or upon shut down of the system/motor controls. FIG. 8D shows that the separation or distance between the arms 808 at the nozzle outlet 804 can have a value h₁.

In contrast, in FIG. 8E, the side cross-section of the nozzle 108 shows that the nozzle shell 803 can linearly slide over the nozzle body 801 to a position closer to the upstream end of the nozzle 108. As described above with FIG. 8B, linearly sliding the nozzle shell face 811 towards the nozzle body 801 causes the arms 808 to pivot inwardly. This movement in the vertical direction results in the arms 808 being moved towards one another at the nozzle outlet 804, squeezing the flow into a fan-shaped stream (e.g., a flat and spread-out stream). In some cases, the stream is squeezed in a vertical direction and results in a spread in a horizontal direction. FIG. 8F shows that the separation or distance between the arms 808 at the nozzle outlet 804 can have a value of h₂, where h₂<h₁. In some cases, h₂ can be approximately half the size of h₁. In some cases, the ratio of h₂/h₁ can be in a range between approximately 0.1 and 0.9, or between approximately 0.2 and 0.7, or between approximately 0.4 and 0.6. In some cases, the nozzle 108 can be coupled to a monitor (e.g., monitor 102 as described herein) that can rotate the orientation of the nozzle 108 and its output. The vertical direction and the horizontal direction used to describe the movement of the arms 808 and the direction of the spread of the stream, respectively, are directions that are taken with respect to the nozzle 108.

In some cases, the nozzle 108 includes a collar 816 (FIG. 8A) on an exterior surface of nozzle 108 that can include one or more protrusions to allow a user to determine an orientation of the nozzle 108 relative to a flow path. In FIG. 8A, the protrusions indicate the “horizontal” dimension in which the spray will spread upon engagement of the motor or manual adjustment mechanism. In contrast, FIGS. 8D and 8F indicate the “vertical” dimension perpendicular to the dimension in which the spray will spread.

In some cases, the nozzle 108 is configured to handle a fluid flow rate in a range between approximately 10 GPM and 1500 GPM at 100 PSI, such as about 500 GPM at 100 PSI, or about 1250 GPM at 100 PSI.

Beneficially, the flow device assembly (e.g., flow device assembly 100 in FIG. 1) is a compact system that can be used in various applications, including firefighting applications. The monitor can include a number of strategically placed bends within the internal flow path coinciding with changes in the cross-sections of the flow paths throughout the monitor (e.g., enlarged cross-sections at locations where the flow path bends are sharp), contributing to the overall compactness and reduced weight of the monitor itself, and enabling it to be retrofitted to surfaces. Further, the monitor can include a plurality of motors to rotate various elements of the monitor. Beneficially, a majority of the electrical connections and wiring, can be disposed internally within the monitor. The monitor can also couple to one or more downstream components. For example, an integrated and shut-off element can be included which facilitates the restriction of the fluid path as desired and can also enable the shut-off of the fluid path entirely, all through a single mechanism. In another example, a stream straightener with an integrated flow meter can be included, which advantageously reduces the turbulence in the fluid flow and thus improves fluid flow pressures. Moreover, an adjustable nozzle can be included, which can enable a fan-shaped (e.g., a flat and spread out) stream of fluid. In some cases, the fan-shaped stream may exit the flow device assembly 100 in a horizontal direction. Because the monitor described herein can include a motor to adjust the orientation of downstream components, the direction of the fan-shaped, or otherwise non-radially-symmetrical stream can be adjusted (e.g., adjusted from a horizontal to a vertical direction). Separate motors can be provided for operation of variable features in the downstream components, such as the variable restriction and shut-off valve combination and the variable nozzle spray shape of the illustrated embodiment.

In some aspects, the techniques described herein relate to a flow device assembly, including: a monitor, wherein the monitor includes: an inlet; an outlet including a rotatable element to connect to one or more components; a fluid pathway extending from the inlet through the outlet, wherein the rotatable element has an axis of rotation about parallel to the fluid pathway at the outlet; and an adjustment component to rotate the rotatable element about the axis of rotation.

In some embodiments, the techniques described herein relate to a flow device assembly, wherein the fluid pathway includes a plurality of bends to facilitate a directional flow of a fluid in the fluid pathway. In some embodiments, the techniques described herein relate to a flow device assembly, wherein the plurality of bends includes a first bend to redirect the fluid from traveling in a first direction to a second direction, a second bend to redirect the fluid from traveling in the second direction to a third direction, a third bend to redirect the fluid from traveling in the third direction to a fourth direction, and a fourth bend to redirect the fluid from traveling in the fourth direction to a fifth direction. In some embodiments, the techniques described herein relate to a flow device assembly, wherein the second direction is approximately 45° relative to the first direction, wherein the third direction is approximately 45° relative to the second direction, wherein the fourth direction is approximately 90° relative to the third direction, and wherein the fifth direction is approximately 90° relative to the fourth direction.

In some embodiments, the techniques described herein relate to a flow device assembly, wherein the adjustment component is a motor configured to drive one or more gears to rotate the rotatable element. In some embodiments, the techniques described herein relate to a flow device assembly, wherein the rotatable element is a swivel element.

In some embodiments, the techniques described herein relate to a flow device assembly, further including a rotation motor to adjust an azimuthal rotation of the monitor relative to a first axis parallel to the fluid pathway at the inlet. In some embodiments, the techniques described herein relate to a flow device assembly, wherein the rotation motor operates with a single stage gear reduction. In some embodiments, the techniques described herein relate to a flow device assembly, further including a handle to facilitate manual control of the azimuthal rotation of the monitor relative to the first axis. In some embodiments, the techniques described herein relate to a flow device assembly, further including an elevation motor to adjust an elevation of the monitor. In some embodiments, the techniques described herein relate to a flow device assembly, wherein the elevation motor operates with a single stage gear reduction. In some embodiments, the techniques described herein relate to a flow device assembly, further including a handle to facilitate manual control of the elevation of the monitor.

In some embodiments, the techniques described herein relate to a flow device assembly, wherein the monitor includes a housing and electrical wiring, wherein a majority of the electrical wiring is disposed on an interior of the housing.

In some embodiments, the techniques described herein relate to a flow device assembly, wherein the rotatable element is adjusted to an angle in a range between approximately 0° and 90°.

In some embodiments, the techniques described herein relate to a flow device assembly, wherein the adjustment component is a motor wherein the one or more components include a nozzle, and wherein the nozzle is configured to expel a fluid in a stream including a flat and triangular shape, wherein a rotation of the rotatable element with the motor comprises the rotation of the flat and triangular shape of the fluid.

In some aspects, the techniques described herein relate to a method of operating a flow device assembly, the method including: providing a monitor having a fluid pathway extending from an inlet through an outlet, an adjustment component and a swivel element disposed at the outlet of the monitor; and rotating the swivel element at the outlet of the monitor in response to the adjustment component, wherein rotating the swivel element rotates an output of the flow device assembly.

In some embodiments, the techniques described herein relate to a method, wherein the adjustment component includes an orientation motor, a first orientation gear, and a second orientation gear. In some embodiments, the techniques described herein relate to a method, further including rotating the first orientation gear with the orientation motor, and rotating the second orientation gear in response to a rotation of the first orientation gear.

In some embodiments, the techniques described herein relate to a method, wherein the fluid pathway includes a plurality of bends to facilitate a directional flow of a fluid in the fluid pathway. In some embodiments, the techniques described herein relate to a method, wherein the plurality of bends includes a first bend to redirect the fluid from traveling in a first direction to a second direction, a second bend to redirect the fluid from traveling in the second direction to a third direction, a third bend to redirect the fluid from traveling in the third direction to a fourth direction, and a fourth bend to redirect the fluid from traveling in the fourth direction to a fifth direction. In some embodiments, the techniques described herein relate to a method, wherein the second direction is approximately 45° relative to the first direction, wherein the third direction is approximately 45° relative to the second direction, wherein the fourth direction is approximately 90° relative to the third direction, and wherein the fifth direction is approximately 90° relative to the fourth direction.

In some embodiments, the techniques described herein relate to a method, further including adjusting an azimuthal rotation of the monitor with a rotation motor that rotates a first rotation gear. In some embodiments, the techniques described herein relate to a method, further including manually adjusting an azimuthal rotation of the monitor with a crank handle. In some embodiments, the techniques described herein relate to a method, further including adjusting a zenith rotation of the monitor with an elevation motor that rotates a first elevation gear. In some embodiments, the techniques described herein relate to a method, further including manually adjusting a zenith rotation of the monitor with a crank handle.

In some embodiments, the techniques described herein relate to a method, wherein the output of the outlet can be adjusted to an angle in a range between approximately 0° and 90°.

In some embodiments, the techniques described herein relate to a method, further including attaching one or more downstream components to the outlet. In some embodiments, the techniques described herein relate to a method, wherein rotating the output results in rotating a nozzle output.

In some aspects, the techniques described herein relate to a flow device assembly, including: a monitor, wherein the monitor includes: a fluid flow path extending from an inlet to an outlet; a monitor body including the inlet and a first motor to adjust a rotation of the monitor about a first axis about parallel to the fluid flow path at the inlet; an outlet arm coupled to the monitor body, wherein the outlet arm includes the outlet having a rotatable element that is rotatable about a second axis about parallel to the fluid flow path at the outlet, and wherein the outlet arm includes a second motor to adjust a rotation of the rotatable element about the second axis; and an elevation drive assembly coupled to the outlet arm and the monitor body, wherein the elevation drive assembly includes a third motor to adjust an elevation of the outlet arm relative to the first axis.

In some embodiments, the techniques described herein relate to a flow device assembly, further including electrical wiring to electrically connect at least one of the first motor, the second motor, and the third motor to a controller, wherein a majority of the electrical wiring is disposed in an internal location of the monitor. In some embodiments, the techniques described herein relate to a flow device assembly, wherein the controller includes a printed circuit board assembly.

In some embodiments, the techniques described herein relate to a flow device assembly, wherein a bottom portion of the monitor body is coupled to a flange base, and wherein the flange base is configured to attach to a surface of a fire truck.

In some embodiments, the techniques described herein relate to a flow device assembly, further including a restriction and shut-off valve element, wherein the restriction and shut-off valve element is coupled to the outlet arm of the monitor. In some embodiments, the techniques described herein relate to a flow device assembly, wherein the restriction and shut-off valve element includes an adjustable restriction element, and wherein the restriction and shut-off valve element is configured to operate with a single mechanism to adjust a flow of fluid.

In some embodiments, the techniques described herein relate to a flow device assembly, further including a nozzle coupled to the monitor, the nozzle to expel a fluid in a stream including a fan-shape.

In some embodiments, the techniques described herein relate to a flow device assembly, wherein the second motor is configured to rotate the rotatable element in a range of approximately 0° to 90°.

In some embodiments, the techniques described herein relate to a flow device assembly, further including a circuitry, a first electrical connector between the circuitry and the first motor, a second electrical connector between the second motor and the circuitry, and a third electrical connector between the third motor and the circuitry. In some embodiments, the techniques described herein relate to a flow device assembly, wherein the first, second, and third electrical connectors are disposed at an internal location of the monitor.

In some embodiments, the techniques described herein relate to a flow device assembly, further including a plurality of single stage gear reductions to be operated with at least one of the first, second, and third motors.

In some embodiments, the techniques described herein relate to a flow device assembly, wherein the monitor is configured to be controlled by a remote. In some embodiments, the techniques described herein relate to a flow device assembly, wherein the remote is hard-wired or battery-operated.

In some embodiments, the techniques described herein relate to a flow device assembly, further including a first hand crank to adjust a rotation of the monitor and a second hand crank to adjust an elevation of the outlet arm.

In some aspects, the techniques described herein relate to a monitor, including: an inlet; an outlet; and a fluid pathway extending from the inlet through an intermediate point to the outlet, wherein the fluid pathway is broadened between the inlet and the intermediate point, and wherein the fluid pathway is narrowed between the intermediate point and the outlet.

In some embodiments, the techniques described herein relate to a monitor, wherein flow path cross-sectional areas transverse to the fluid pathway are larger at the intermediate point than at the inlet, and larger at the inlet than at the outlet.

In some embodiments, the techniques described herein relate to a monitor, wherein the fluid pathway includes a plurality of bends to direct a flow of a fluid in the fluid pathway. In some embodiments, the techniques described herein relate to a monitor, wherein the plurality of bends includes at least a first bend to redirect the fluid from traveling in a first direction to a second direction, a second bend to redirect the fluid from traveling in the second direction to a third direction, a third bend to redirect the fluid from traveling in the third direction to a fourth direction, and a fourth bend to redirect the fluid from traveling in the fourth direction to a fifth direction. In some embodiments, the techniques described herein relate to a monitor, wherein at least one of the third bend and the fourth bend includes a bend angle of approximately 90°. In some embodiments, the techniques described herein relate to a monitor, wherein at least one of the third bend and the fourth bend includes a plurality of vanes to reduce turbulence in the fluid pathway. In some embodiments, the techniques described herein relate to a monitor, wherein the intermediate point coincides with the third bend or the fourth bend.

In some aspects, the techniques described herein relate to a method of forming a flow device assembly, the method including: forming a monitor, including: coupling a monitor body to a base, wherein the monitor body includes a first motor to adjust a rotation of the monitor about a first axis; coupling an outlet arm to the monitor body, wherein the outlet arm includes an outlet having a rotatable element and a second motor, wherein a fluid flow path extends from an inlet to the outlet and the rotatable element is rotatable about a second axis that is about parallel to the fluid flow path at the outlet, and wherein the second motor is configured to rotate the rotatable element about the second axis.

In some embodiments, the techniques described herein relate to a method, further including coupling an elevation drive assembly to the outlet arm and the monitor body, wherein the elevation drive assembly includes a third motor to adjust an elevation of the outlet arm relative to the first axis.

In some embodiments, the techniques described herein relate to a method, further including coupling a stream straightener component to the outlet, the stream straightener component to reduce a turbulence of a fluid transferred along the fluid flow path.

In some embodiments, the techniques described herein relate to a method, further including coupling a nozzle to the monitor. In some embodiments, the techniques described herein relate to a method, wherein the nozzle expels fluid having a fan shape.

In some embodiments, the techniques described herein relate to a method, wherein the second motor adjusts an orientation of the fluid flow path in a range from 0° to 90°.

In some embodiments, the techniques described herein relate to a method, further including coupling a combined fluid restriction element and a shut-off valve element between the monitor and a nozzle.

In some aspects, the techniques described herein relate to a flow device assembly including: a monitor including a first fluid pathway between an inlet and an outlet, wherein the first fluid pathway includes a first transverse cross-sectional area at the inlet, a second transverse cross-sectional area at an intermediate point between the inlet and the outlet, and a third transverse cross-sectional area at the outlet, wherein the second transverse cross-sectional area is larger than the first transverse cross-sectional area and the third transverse cross-sectional area; and a first downstream component coupled to the monitor, wherein the first downstream component includes a second fluid pathway in fluid communication with the first fluid pathway.

In some embodiments, the techniques described herein relate to a flow device assembly, wherein the first downstream component is at least one of a restriction and shut-off element, a stream straightener component, and a nozzle.

In some embodiments, the techniques described herein relate to a flow device assembly, further including a second downstream component. In some embodiments, the techniques described herein relate to a flow device assembly, further including a third downstream component. In some embodiments, the techniques described herein relate to a flow device assembly, wherein the first downstream component is a restriction and shut-off element, wherein the second downstream component is a stream straightener component, and wherein the third downstream component is a nozzle.

In some aspects, the techniques described herein relate to an integrated restriction and shut-off element including: a restriction component to restrict a flow of a fluid; a shut-off element; and a common control mechanism for varying flow restriction of the restriction component and switching the shut-off element between on and off states.

In some embodiments, the techniques described herein relate to an integrated restriction and shut-off element, wherein the common control mechanism includes a motor to drive a rotation of a plurality of gears to vary the flow restriction of the restriction component and switching of the shut-off element between the on and off states. In some embodiments, the techniques described herein relate to an integrated restriction and shut-off element, wherein the common control mechanism includes a handle to manually rotate a plurality of gears to vary the flow restriction of the restriction component and switching of the shut-off element between the on and off states. In some embodiments, the techniques described herein relate to an integrated restriction and shut-off element, wherein the shut-off element includes a quarter-turn ball valve. In some embodiments, the techniques described herein relate to an integrated restriction and shut-off element, wherein the restriction component includes a first restriction element having a plurality of first lobes and a second restriction element having a plurality of second lobes, wherein alignment of the plurality of first lobes and the plurality of second lobes corresponds to maximal flow of the fluid through the integrated restriction and shut-off element, and wherein misalignment of the plurality of first lobes and the plurality of second lobes corresponds to maximal restriction of flow of the fluid through the integrated restriction and shut-off element. In some embodiments, the techniques described herein relate to an integrated restriction and shut-off element, wherein the first restriction element is fixed, and wherein the second restriction element is movable relative to the first restriction element.

In some aspects, the techniques described herein relate to a nozzle including: a body including an inlet and an outlet; and a spray shape-adjusting assembly positioned closer to the outlet than the inlet, the spray shape-adjusting assembly including: a first arm and a second arm, wherein the first arm and the second arm are disposed on opposite sides of a flow path extending from the inlet through the outlet, wherein the spray shape-adjusting assembly is configured to relatively move the first arm and the second arm with respect to one another along a first direction to spread a fluid exiting the outlet in a second direction, wherein the first direction is perpendicular to the second direction.

In some embodiments, the techniques described herein relate to a nozzle, wherein the inlet of the nozzle is coupled to a monitor for a firefighting application. In some embodiments, the techniques described herein relate to a nozzle, further including a motor to electrically operate the spray shape-adjusting assembly. In some embodiments, the techniques described herein relate to a nozzle, wherein the spray shape-adjusting assembly includes at least a portion of the body coupled to the first arm and the second arm, and wherein the spray shape-adjusting assembly includes a nozzle shell face, wherein the nozzle shell face engages with the first arm and the second arm. In some embodiments, the techniques described herein relate to a nozzle, wherein the first arm includes a first end and a second end, the first end nearer to the inlet than the outlet, wherein the second arm includes a corresponding first end and a corresponding second end, the corresponding first end nearer to the inlet than the outlet, and wherein the spray shape-adjusting assembly is configured to adjust a proximity of the second end of the first arm to the corresponding second end of the second arm to adjust a shape of a fluid exiting the outlet. In some embodiments, the techniques described herein relate to a nozzle, wherein the spray shape-adjusting assembly includes a pivoting mechanism to adjust the proximity of the second end of the first arm to the corresponding second end of the second arm. In some embodiments, the techniques described herein relate to a nozzle, wherein a linear actuator adjusts the proximity of the second end of the first arm and the corresponding second end of the second arm. In some embodiments, the techniques described herein relate to a nozzle, wherein a linear, manual operation of the spray shape-adjusting assembly adjusts the proximity of the second end of the first arm and the corresponding second end of the second arm. In some embodiments, the techniques described herein relate to a nozzle, wherein a reduction in the proximity of the second end of the first arm to the corresponding second end of the second arm flattens and spreads out the shape of the fluid exiting the outlet.

In some aspects, the techniques described herein relate to a nozzle including: an inlet; an outlet, wherein a flow path extends from the inlet through the outlet; and a first arm, wherein a movement of the first arm towards the flow path corresponds to a flattened shape of a fluid exiting the outlet, wherein the movement of the first arm is in a first direction, and wherein the flattened shape of the fluid exiting the outlet is spread in a second direction perpendicular to the first direction.

In some embodiments, the techniques described herein relate to a flow device assembly for firefighting, including: a monitor; and the nozzle, wherein the nozzle is coupled to the monitor. In some embodiments, the techniques described herein relate to a nozzle, further including a motor to electrically operate the first arm. In some embodiments, the techniques described herein relate to a nozzle, further including a second arm disposed opposite the first arm across the flow path, wherein the first arm and the second arm are configured to both move towards or away from the flow path to adjust a shape of the fluid exiting the outlet. In some embodiments, the techniques described herein relate to a nozzle, further including a nozzle shell face disposed nearer the outlet than the inlet, wherein the first arm includes a first end and a second end, wherein the second end engages with a portion of the nozzle shell face, wherein an adjustment of the portion of the nozzle shell face relative to the first arm corresponds to a movement of the first arm towards the flow path or a movement of the first arm away from the flow path. In some embodiments, the techniques described herein relate to a nozzle, wherein a linear actuator adjusts an amount of the movement of the first arm toward the flow path or an amount of the movement of the first arm away from the flow path. In some embodiments, the techniques described herein relate to a nozzle, wherein a manual operation adjusts an amount of the movement of the first arm toward the flow path or an amount of the movement of the first arm away from the flow path.

In some aspects, the techniques described herein relate to a nozzle including: an inlet; an outlet, wherein a flow path extends from the inlet through the outlet; and a motor to electrically operate a first arm, wherein the first arm is configured to move towards or away from a flow path, and wherein the motor provides an initial stream configuration including a most confined spray configuration relative to other spray configurations for the nozzle.

In some embodiments, the techniques described herein relate to a nozzle, wherein the initial stream configuration includes a straight stream. In some embodiments, the techniques described herein relate to a nozzle, wherein a movement of the first arm towards the flow path corresponds to a flattened and widened shape of a fluid exiting the outlet. In some embodiments, the techniques described herein relate to a nozzle, further including a second arm, wherein the motor is configured to electrically operate the second arm in a mirror operation to that of the first arm. In some embodiments, the techniques described herein relate to a flow device assembly for firefighting, including: a monitor; and the nozzle, wherein the nozzle is coupled to the monitor to provide a continuous flow path from the monitor through the nozzle.

Unless the context clearly requires otherwise, throughout the description and the claims, the words “comprise,” “comprising,” “include,” “including” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Moreover, as used herein, when a first element is described as being “on” or “over” a second element, the first element may be directly on or over the second element, such that the first and second elements directly contact, or the first element may be indirectly on or over the second element such that one or more elements intervene between the first and second elements. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments.

While certain embodiments have been described, these embodiments have been presented by way of example only, and are not intended to limit the scope of the disclosure. Indeed, the novel apparatus, methods, and systems described herein may be embodied in a variety of other forms; furthermore, various omissions, substitutions and changes in the form of the methods and systems described herein may be made without departing from the spirit of the disclosure. For example, while blocks are presented in a given arrangement, alternative embodiments may perform similar functionalities with different components and/or circuit topologies, and some blocks may be deleted, moved, added, subdivided, combined, and/or modified. Each of these blocks may be implemented in a variety of different ways. Any suitable combination of the elements and acts of the various embodiments described above can be combined to provide further embodiments. The accompanying claims and their equivalents are intended to cover such forms or modifications as would fall within the scope and spirit of the disclosure.

1. A flow device assembly, comprising:
a monitor, wherein the monitor comprises:
an inlet;
an outlet comprising a rotatable element to connect to one or more components;
a fluid pathway extending from the inlet through the outlet, wherein the rotatable element has an axis of rotation about parallel to the fluid pathway at the outlet; and
an adjustment component to rotate the rotatable element about the axis of rotation.

2. The flow device assembly of claim 1, wherein the fluid pathway comprises a plurality of bends to facilitate a directional flow of a fluid in the fluid pathway, wherein the plurality of bends comprises a first bend to redirect the fluid from traveling in a first direction to a second direction, a second bend to redirect the fluid from traveling in the second direction to a third direction, a third bend to redirect the fluid from traveling in the third direction to a fourth direction, and a fourth bend to redirect the fluid from traveling in the fourth direction to a fifth direction, wherein the second direction is approximately 45° relative to the first direction, wherein the third direction is approximately 45° relative to the second direction, wherein the fourth direction is approximately 90° relative to the third direction, and wherein the fifth direction is approximately 90° relative to the fourth direction.

3. (canceled)

4. (canceled)

5. The flow device assembly of claim 1, wherein the adjustment component is a motor configured to drive one or more gears to rotate the rotatable element.

6. The flow device assembly of claim 1, wherein the rotatable element is a swivel element.

7. The flow device assembly of claim 1, further comprising a rotation motor to adjust an azimuthal rotation of the monitor relative to a first axis parallel to the fluid pathway at the inlet.

8. (canceled)

9. (canceled)

10. The flow device assembly of claim 1, further comprising an elevation motor to adjust an elevation of the monitor.

11. (canceled)

12. (canceled)

13. The flow device assembly of claim 1, wherein the monitor comprises a housing and electrical wiring, wherein a majority of the electrical wiring is disposed on an interior of the housing.

14. The flow device assembly of claim 1, wherein the rotatable element is adjusted to an angle in a range between approximately 0° and 90°.

15. The flow device assembly of claim 1, wherein the adjustment component is a motor, wherein the one or more components comprise a nozzle, and wherein the nozzle is configured to expel a fluid in a stream comprising a flat and triangular shape, wherein a rotation of the rotatable element with the motor comprises the rotation of the flat and triangular shape of the fluid.

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. A monitor, comprising:
an inlet;
an outlet; and
a fluid pathway extending from the inlet through an intermediate point to the outlet, wherein the fluid pathway is broadened between the inlet and the intermediate point, and wherein the fluid pathway is narrowed between the intermediate point and the outlet.

44. The monitor of claim 43, wherein flow path cross-sectional areas transverse to the fluid pathway are larger at the intermediate point than at the inlet, and larger at the inlet than at the outlet.

45. The monitor of claim 43, wherein the fluid pathway comprises a plurality of bends to direct a flow of a fluid in the fluid pathway, wherein the plurality of bends comprises at least a first bend to redirect the fluid from traveling in a first direction to a second direction, a second bend to redirect the fluid from traveling in the second direction to a third direction, a third bend to redirect the fluid from traveling in the third direction to a fourth direction, and a fourth bend to redirect the fluid from traveling in the fourth direction to a fifth direction.

46. (canceled)

47. The monitor of claim 45, wherein at least one of the third bend and the fourth bend comprises a bend angle of approximately 90°.

48. The monitor of claim 47, wherein at least one of the third bend and the fourth bend comprises a plurality of vanes to reduce turbulence in the fluid pathway.

49. The monitor of claim 47, wherein the intermediate point coincides with the third bend or the fourth bend.

50. (canceled)

51. (canceled)

52. (canceled)

53. (canceled)

54. (canceled)

55. (canceled)

56. (canceled)

57. A flow device assembly comprising:
a monitor comprising a first fluid pathway between an inlet and an outlet, wherein the first fluid pathway comprises a first transverse cross-sectional area at the inlet, a second transverse cross-sectional area at an intermediate point between the inlet and the outlet, and a third transverse cross-sectional area at the outlet, wherein the second transverse cross-sectional area is larger than the first transverse cross-sectional area and the third transverse cross-sectional area; and
a first downstream component coupled to the monitor, wherein the first downstream component comprises a second fluid pathway in fluid communication with the first fluid pathway.

58. The flow device assembly of claim 57, wherein the first downstream component is at least one of a restriction and shut-off element, a stream straightener component, and a nozzle.

59. The flow device assembly of claim 57, further comprising a second downstream component.

60. The flow device assembly of claim 59, further comprising a third downstream component.

61. The flow device assembly of claim 60, wherein the first downstream component is a restriction and shut-off element, wherein the second downstream component is a stream straightener component, and wherein the third downstream component is a nozzle.

62. (canceled)

63. (canceled)

64. (canceled)

65. (canceled)

66. (canceled)

67. (canceled)

68. (canceled)

69. (canceled)

70. (canceled)

71. (canceled)

72. (canceled)

73. (canceled)

74. (canceled)

75. (canceled)

76. (canceled)

77. (canceled)

78. (canceled)

79. (canceled)

80. (canceled)

81. (canceled)

82. (canceled)

83. (canceled)

84. (canceled)

85. (canceled)

86. (canceled)

87. (canceled)

88. (canceled)
